(19) United States
(12) Patent Application Publication
(10) Pub. No.: US 2005/0114267 A1
(43) Pub. Date: May 26, 2005

(54) License-authentication functioned output system, output apparatus, data authentication apparatus, design resource output program, data authentication program and license authentication output method

(75) Inventors: Shinji Miwa, Nirasaki-shi (JP); Toshio Tanaka, Shiojiri-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/959,373

(22) Filed: Oct. 7, 2004

(30) Foreign Application Priority Data
Oct. 8, 2003 (JP) 2003-349606
Jul. 2, 2004 (JP) 2004-196847

(51) Int. Cl. H04L 9/00

(52) U.S. Cl. 705/59

(57) ABSTRACT

Exemplary embodiments provide a license-authentication functioned output system which enables data protection positive and enhances and/or improves a user's convenience, further being suited to reduce processing load. A printer receives document data and a user ID and sends design resource-data authentication information and the user ID included in the document data, together with an authentication request, to a data authentication server. When a use-permitting information is received, it prints a design resource within a use-permitted scope depending upon the use-permitting information and design resource data. A data authentication server searches through a license information register table on the basis of the authentication information and reads out license information concerned. The data authentification server decides whether or not the received user ID is included in the license information. When it is decided that the user ID is included, the use-permitting information included in the license information is sent to the printer.

### BACKGROUND OF THE INVENTION

1. Field of Invention

Exemplary embodiments of the present invention relate to a system, apparatus, program and method for outputting an element through the authentication of available right, and more particularly to a license-authentication functioned output system, output apparatus, data authentication apparatus, design resource output program, data authentication program and license authentication output method which enables data protection positive and enhances and/or improves user's convenience, further being suited to reduce processing load.

2. Description of Related Art

In the related art, there are arts for protecting copyright of documents and images as works, including a document-management method as disclosed in related art document JP-A-10-320289 and an image-forming apparatus as disclosed in related art document JP-A-2002-287919.

JP-A-10-320289 describes the invention configured with a copyright management information setting section, a document storing section, a copyright management information storing section, a copyright management information checking section and a document generating section. The copyright management information setting section sets copyright management information based on a constituent unit of the documents stored in the document storing section. The copyright management information thus set, together with the information representative of the constituent unit based on which the copyright management information has been set, are stored to the copyright management information storing section by placing a correspondence between them. When the document generating section makes a request to use a predetermined part of another document stored in the document storing section during document generation, the copyright management information checking section determines an available portion within the predetermined part according to the copyright management information, on a constituent unit overlapping with the predetermined part and stored in the copyright management information storing section.

In the invention described in JP-A-2002-287919, encrypted data is received and decrypted by the apparatus having at least a print function, to print decrypted data onto a recording medium.

### SUMMARY OF THE INVENTION

The invention described in JP-A-10-320289 is configured such that, when a predetermined part of another document is requested for use, an available portion is determined within the predetermined part according to the copyright management information in a constituent unit lying overlapped with the predetermined part. Consequently, despite document change possible in relation to another document, the document itself can be printed comparatively in a free way. Meanwhile, document protection is based on the single apparatus, the document can be changed at another apparatus. Accordingly, there is a problem that copyright protection is insufficient.

Meanwhile, the invention of JP-A-2002-287919 is configured to protect a document by encrypting the print data of the document. Even the authorized user might be limited in editing or displaying a document, thus leaving a problem of inconvenience of use. Further, there is also a problem of heavy processing load because of the necessity of encryption and decryption processes.

Therefore, exemplary embodiments of the present invention have been made by putting the eye on such unsolved problems involved in the related arts. Exemplary embodiments provide a license-authentication functioned output system, output apparatus, data authentication apparatus, design resource output program, data authentication program and license authentication output method to make data protection positive and enhance and/or improve user's convenience, further being suited for reducing process load.

In order to address or achieve the above and/or other objects, a license-authentication functioned output system of exemplary embodiment 1 is a license-authentication functioned output system to output a design resource apparatus and limiting to output the design resource depending upon design resource data, the license-authentication functioned output system including:
a license information storing device to store license information, including use-permitting information defining a use-permitted scope of the design resource data and subject identification information identifying a subject of use of the design resource data, by a correspondence to authentication information;
a design resource data input device to input the design resource data to which the authentication information is placed in correspondence;
a subject identification information input device to input the subject identification information;
a license information search device to search through the license information storing device on the basis of the authentication information placed in correspondence to the design resource data inputted by the design resource data input device and reading out license information concerned;
a data authentication device to authenticate a use of the design resource data depending upon the license information read out by the license information search device; and
a design resource output device to output the design resource depending upon the design resource data;
the data authentication device being adapted to decide whether or not the subject identification information inputted by the subject identification information input device is included in the license information read out by the license information search device;
the design resource output device being adapted to output the design resource within a use-permitted scope depending upon the use-permitting information included in the license information read out by the license information search device and the design resource data inputted by the design resource data input device when the data authentication device decides that the subject identification information is included.

With this configuration, in case the user provides design resource data intended for output and subject identification information about himself/herself, the design resource data input device inputs design resource data to which authentication information is placed in correspondence, while the subject identification information input device inputs subject identification information. The license information search device searches through the license information storing device on the basis of the authentication information placed in correspondence to the input design resource data thereby reading out license information concerned. The data authentication device decides whether or not the inputted subject identification information is included in the license information read out. As a result, when it is decided that the subject identification information is included, the design resource output device outputs a design resource within a use-permitted scope depending upon the use-permitting information included in the read license information and the inputted design resource data.

Accordingly, the design resource is outputted within a use-permitted scope depending upon the use-permitting information. Accordingly, by setting of use-permitting information, design resource display, printing or other output can be limited thus, providing an effect that design resource data can be protected comparatively positively as compared to the related art. Furthermore, the authorized user is free from limitation in design resource display, printing or other output. Meanwhile, even for design resource data that cannot be outputted, the design resource data can be outputted by suitably updating license information. Accordingly, it is possible to obtain an effect that user's convenience can be comparatively enhanced or improved as compared to the related art. Furthermore, because of no encryption and decryption processes, there is obtained an effect that processing load can be reduced as compared to the related art.

Here, design resource data includes character data, image data, printing data, projection data, voice data and every one of data to be protected. This is true for the ensuing license-authentication functioned output system in the exemplary embodiment 2, output apparatus in exemplary embodiment 13, data authentication apparatus in exemplary embodiment 24, design resource output program in exemplar-y embodiment 29, data authentication program in exemplary embodiment 39 and license authentication output method in exemplary embodiment 44.

Meanwhile, the design resource data to which authentication information is placed in correspondence includes, for example, design resource data including authentication information and design resource data including link information to authentication information. This is true for the ensuing license-authentication functioned output system in exemplary embodiment 2, output apparatus in exemplary embodiment 13, data authentication apparatus in exemplary embodiment 24, design resource output program in exemplary embodiment 29, data authentication program in the exemplary embodiment 39 and license authentication output method in exemplary embodiment 44.

Meanwhile, although license information includes use-permitting information and subject identification information, the data structure includes a data structure including one or a plurality of pieces of use-permitting information and the corresponding subject identification information, and a data structure including one or a plurality of pieces of subject identification information and the corresponding use-permitting information. This is true for the ensuing license-authentication functioned output system in exemplary embodiment 2, output apparatus in exemplary embodiment 13, data authentication apparatus in exemplary embodiment 24, design resource output program in exemplary embodiment 29, data authentication program in exemplary embodiment 39 and license authentication output method in exemplary embodiment 44.

Meanwhile, use-permitted scope represents to what degree design resource data can be used. Namely, scope means a scope of degree. Incidentally, use-permitted scope refers to a scope where use is permitted. In other words, it corresponds to a matter meeting a condition/rule where use is permitted. This is true for the ensuing license-authentication functioned output system in exemplary embodiment 2, output apparatus in exemplary embodiment 13, data authentication apparatus in exemplary embodiment 24, design resource output program in exemplary embodiment 29, data authentication program in exemplary embodiment 39 and license authentication output method in exemplary embodiment 44.

Meanwhile, the design resource data input device may be in any configuration provided that it is adapted to input design resource data, e.g., it may be made to acquire or receive design resource data, or to read design resource data out of storage device. This is true for the ensuing license-authentication functioned output system in exemplary embodiment 2, output apparatus in exemplary embodiment 13, data authentication apparatus in exemplary embodiment 24, design resource output program in exemplary embodiment 29 and data authentication program in exemplary embodiment 39.

Meanwhile, the subject identification information input device may be in any configuration provided that it is adapted to input subject identification information, e.g., it may be made to acquire or receive subject identification information, or to read subject identification information out of a storage device. This is true for the ensuing license-authentication functioned output system in exemplary embodiment 2, output apparatus in exemplary embodiment 13, data authentication apparatus in exemplary embodiment 24, design resource output program in exemplary embodiment 29 and data authentication program in exemplary embodiment 39.

Meanwhile, the license information storing device is to store license information by every device and at all times. It may previously store license information or store license information by external input or so during operation of the present system without previously storing license information. This is true for the ensuing license-authentication functioned output system in exemplary embodiment 2, output apparatus in exemplary embodiment 13 and data authentication apparatus in exemplary embodiment 24.

Meanwhile, the present system may be realized as a single apparatus, terminal or other equipment, or may be realized as a network system communicatably connected with a plurality of apparatuses, terminals or other equipments. In the latter case, the constituent elements may belong to any of a plurality of equipments provided that they are communicatably connected. The constituent elements, belonging to a plurality of equipments, etc. refers to that each of the license information storing devices, the design resource data input device, the subject identification information input device, the license information search device, the data authentication device and the design resource output device belongs to any of a plurality of equipments, etc., that each of the devices is divided into one or a plurality of functions wherein each function of the above devices belongs to any of a plurality of equipments, etc., that or each piece of information, etc. of use-permitting information, subject identification information, license information, authentication information and design resource data belongs to any of a plurality of equipments, etc. Namely, constituent elements include the entire or a part of each device and information, data and other elements.

Furthermore, a license-authentication functioned output system of exemplary embodiment 2 is a license-authentication functioned output system connected communicatably with a output apparatus to output a design resource depending upon design resource data and a data authentication apparatus to authenticate a use of the design resource data thereby limiting to output the design resource.

The output apparatus has a design resource data input device to input the design resource data to which authentication information is placed in correspondence, a subject identification information input device to input the subject identification information identifying a subject of use of the design resource data, an authentication request transmitting device to send, together with an authentication request, authentication information placed in correspondence to the design resource data inputted by the design resource data input device and the subject identification information inputted by the subject identification information input device to the data authentication apparatus, and design resource output device to output the design resource depending upon the design resource data.

The data authentication apparatus has a license information storing device to store license information including use-permitting information defining a use-permitted scope of the design resource data and subject identification information by a correspondence to the authentication information, a authentication request receiving device to receive the authentication information and the subject identification information together with the authentication request, a license information search device to search through the license information storing device on the basis of the authentication information received by the authentication request receiving device and reading out license information concerned, and data authentication device to authenticate a use of the design resource data depending upon the license information read out by the license information search device.

The data authentication device being adapted to decide whether or not the subject identification information received by the authentication request receiving device is included in the license information read out by the license information search device, and sending the use-permitting information included in the license information read out by the license information search device to the output apparatus when it is decided that the subject identification information is included.

The design resource output device being adapted to output the design resource within a use-permitted scope depending upon the use-permitting information received and the design resource data inputted by the design resource data input device when the output apparatus received the use-permitting information.

With this configuration, the user provides the output apparatus with design resource data intended for output and subject identification information about himself/herself.

At the output apparatus, the design resource data input device inputs design resource data to which authentication data is placed in correspondence while the subject identification information input device inputs subject identification information. The authentication request transmitting device sends the authentication information placed in correspondence to the input design resource data and inputted subject identification information, together with an authentication request, to the data authentication apparatus.

At the data authentication apparatus, when the authentication request receiving device receives the authentication information and subject identification information together with the authentication request, the license information search device searches through the license information storing device on the basis of the received authentication information and reads out license information concerned. Then, the data authentication device decides whether or not the received subject identification information is included in the license information read out. As a result, when it is decided that the subject identification information is included, the use-permitting information included in the license information read out is sent to the output apparatus.

At the output apparatus, when receiving the use-permitting information, the design resource output device outputs a design resource within a use-permitted scope depending upon the received use-permitting information and inputted design resource data.

Due to this, because the design resource is outputted within the use-permitted scope depending upon the use-permitting information, design resource can be limited in display, printing or other output by the setting of use-permitting information. Meanwhile, because design resource output is limited by collaboration with the data authentication apparatus, design resource output can be similarly limited on another output apparatus. Accordingly, it is possible to obtain an effect that design resource data can be protected comparatively positively as compared to the related art. Furthermore, for an authorized user, the design resource is not limited in display, printing or other output. Meanwhile, for design resource data that could not be outputted, the design resource data can be outputted by suitably updating its license information. Accordingly, it is possible to obtain an effect that user's convenience can be enhanced and/or improved as compared to the related art. Furthermore, because there are no encryption and decryption processes, it is possible to obtain an effect that processing load can be reduced as compared to the related art.

Furthermore, a license-authentication functioned output system of exemplary embodiment 3 is a license-authentication functioned output system according to exemplary embodiment 2, the license information including data confirming information to confirm a content of the design resource data.

The output apparatus has data confirming information generating device to generate data confirming information to confirm a content of the design resource data depending upon design resource data inputted by the design resource data input device.

The authentication request transmitting device being adapted to send the authentication information, the subject identification information and the data confirming information generated by the data confirming information generating device, together with the authentication request, to the data authentication apparatus.

The authentication request receiving device is adapted to receive, together with the authentication request, the authentication information, the subject identification information and the data confirming information.

The data authentication device further deciding whether or not a predetermined relationship is satisfied by the data confirming information received by the authentication request receiving device and the data confirming information included in the license information read out by the license information search device, and sending the use-permitting information included in the license information read out by the license information search device to the output apparatus when it is decided that the predetermined relationship is satisfied and that the subject identification information is included in the license information.

With this configuration, at the output apparatus, the data-confirming information generating device generates data-confirming information to confirm a content of the design resource data, depending upon inputted design resource data. Then, the authentication request transmitting device sends the authentication information placed in correspondence to the inputted design resource data, the inputted subject identification information and the generated data-confirming information, together with an authentication request, to the data authentication apparatus.

At the data authentication apparatus, when the authentication request receiving device receives the authentication information, the subject identification information and the data-confirming information together with the authentication request, the license information search device searches through the license information storing device depending upon the received authentication information and reads out license information concerned. Then, the data authentication device decides whether or not a predetermined relationship is satisfied by the received data-confirming information and the data-confirming information included in the read-out license information. As a result, when it is decided that the predetermined relationship is satisfied and that the subject identification information is included in the license information, the use-permitting information included in the read-out license information is sent to the output apparatus.

At the output apparatus, when the use-permitting information is received, the design resource output device outputs a design resource within a use-permitted scope depending upon the received use-permitting information and input design resource data.

Due to this, when a predetermined relationship is not satisfied by the data-confirming information generated by the design resource output device upon outputting and the data-confirming information held by the data authentication apparatus, the design resource is limited in display, printing or other output. Thus, it is possible to obtain an effect that design resource data can be protected further positively.

Here, satisfying a predetermined relationship includes, for example, an agreement between one of data-confirming information and the other of data-confirming information, an agreement between the result of predetermined operation on one of data-confirming information and the other of data-confirming information, and an agreement between the result of predetermined operation on one of data-confirming information and the result of predetermined operation on the other of data-confirming information. This is true for the ensuing data authentication apparatus in the exemplary embodiment 25, data authentication program in exemplary embodiment 40 and license authentication output method in the exemplary embodiment 46.

Furthermore, a license-authentication functioned output system of exemplary embodiment 4 is a license-authentication functioned output system according to any one of exemplary embodiments 2 and 3, the output apparatus and the data authentication apparatuses in plurality being communicatably connected together,

The output apparatus is adapted to make an inquiry about authentication to a particular one of the data authentication apparatuses in plurality.

With this configuration, the output apparatus makes an inquiry about authentication to a particular one of a plurality of data authentication apparatuses.

Due to this, if inquiry about authentication is made only to a particular data authentication apparatus under duly management, it is possible to secure the legitimacy of license information. Therefore, it is possible to obtain an effect that design resource data can be protected further positively.

Here, inquiry to a particular data authentication apparatus includes, more concretely, previously setting access information to the data authentication apparatus as a destination of inquiry among a plurality of data authentication apparatuses thereby making an inquiry based on the access information, for example. This is true for the ensuing output apparatus of exemplary embodiment 15, design resource output program in exemplary embodiment 31, and license authentication output method in exemplary embodiment 47.

Furthermore, a license-authentication functioned output system of exemplary embodiment 5 is a license-authentication functioned output system according to any exemplary embodiments 2 and 3, the output apparatus and the data authentication apparatuses in plurality being communicatably connected together,

The output apparatus have an apparatus-authenticating device to authenticate a reliability of the data authentication apparatus, and being adapted to make an inquiry about authentication to an authenticated one of the data authentication apparatuses in plurality.

With this configuration, at the output apparatus, the data authentication apparatus authenticate a reliability of the data authentication apparatus. Inquiry about authentication is made to an authenticated one by the apparatus authentication device of among the plurality of data authentication apparatuses.

Due to this, because inquiry about authentication is made to a data authentication apparatus authenticated by the apparatus authentication device, it is possible to secure a legitimacy of license information. Therefore, it is possible to obtain an effect that design resource data can be protected further positively.

Furthermore, a license-authentication functioned output system of exemplary embodiment 6 is a license-authentication functioned output system according to any one of exemplary embodiments 2 to 5, the subject identification information being apparatus identification information to identify the output apparatus.

With this configuration, at the output apparatus, the authentication request transmitting device sends authentication information and apparatus identification information together with an authentication request to the data authentication apparatus.

At the data authentication apparatus, when the authentication request receiving device receives the authentication information and apparatus identification information together with the authentication request, the data authentication device decides whether or not the received apparatus identification information is included in the read-out license information.

Due to this, it is possible to obtain an effect that use-permitted scope can be established based on each output apparatus.

Furthermore, a license-authentication functioned output system of exemplary embodiment 7 is a license-authentication functioned output system according to any one of exemplary embodiments 2 to 5, the subject identification information being user identification information to identify a user who is to use the design resource data.

With this configuration, at the output apparatus, the authentication request transmitting device sends authentication information and user identification information together with an authentication request to the data authentication apparatus.

At the data authentication apparatus, when the authentication request receiving device receives the authentication information and user identification information together with the authentication request, the data authentication device decides whether or not the received user identification information is included in the read-out license information.

Due to this, it is possible to obtain an effect that use-permitted scope can be established based on each user.

Furthermore, a license-authentication functioned output system of exemplary embodiment 8 is a license-authentication functioned output system according to any one of exemplary embodiments 2 to 7, the design resource output device being adapted to decide depending upon the received use-permitting information whether or not the use is outside a use-permitted scope, and limit to output the design resource data inputted by the design resource data input device when it is decided that the use is outside a use-permitted scope.

With this configuration, at the output apparatus, the design resource output device decides whether or not the use is outside a use-permitted scope depending upon the received use-permitting information. As a result, when it is decided that the use is outside a use-permitted scope, the design resource data inputted is limited in output.

Due to this, because even an authorized user can be limited in output in the case of the use outside a use-permitted scope, it is possible to obtain an effect that design resource data can be protected further positively.

Furthermore, a license-authentication functioned output system of exemplary embodiment 9 is a license-authentication functioned output system according to any one of exemplary embodiments 2 to 7, the design resource output device is adapted to decide depending upon the received use-permitting information whether or not the use is outside a use-permitted scope, and output the design resource by a predetermined output limiting process depending upon the design resource data inputted by the design resource data input device when it is decided that the use is outside a use-permitted scope.

With this configuration, at the output apparatus, the design resource output device decides whether or not the use is outside a use-permitted scope depending upon the received use-permitting information. As a result, when it is decided that the use is outside a use-permitted scope, the design resource data inputted is limited in output depending upon the input design resource data.

Due to this, because even an authorized user can be limited in output in the case of the use outside a use-permitted scope, it is possible to obtain an effect that design resource data can be protected further positively.

Furthermore, a license-authentication functioned output system of exemplary embodiment 10 is a license-authentication functioned output system according to any one of exemplary embodiments 2 to 7, the design resource output device being adapted to decide depending upon the received use-permitting information whether or not the use is outside a use-permitted scope, and limit to output the design resource data inputted by the design resource data input device and another one of design resource data to be outputted together with the relevant design resource data when it is decided that the use is outside a use-permitted scope.

With this configuration, at the output apparatus, the design resource output device decides whether or not the use is outside a use-permitted scope depending upon the received use-permitting information. As a result, when it is decided that the use is outside a use-permitted scope, the design resource data inputted and other design resource data to be outputted together with the design resource data is limited in output.

Due to this, because even an authorized user can be limited in output in the case of the use outside a use-permitted scope, it is possible to obtain an effect that design resource data can be protected further positively.

Here, the other design resource data to be outputted together with the design resource data refers to, for example, design resource data (in printing data) to be printed onto the same page, image data to be displayed simultaneously on the screen and so on.

Furthermore, a license-authentication functioned output system of exemplary embodiment 11 is a license-authentication functioned output system according to any one of exemplary embodiments 2 to 10, the license information includes output limiting information defining an output limiting way of the design resource data, output limiting device to limit output of the design resource.

The data authentication device is adapted to decide whether or not the subject identification information received by the authentication request receiving device is included in the license information read out by the license information search device, and send to the output limiting device, output limiting information included in the license information read out by the license information search device when it is decided that the subject identification information is not included.

The output limiting device is adapted to limit output of the design resource depending upon the received output limiting information when the output limiting information is received.

With this configuration, at the data authentication apparatus, the data authentication device decides whether or not the received subject identification information is included in the read-out license information. As a result, when it is decided that the received subject identification information is not included, the output-limiting information included in the read-out license information is sent to the output limiting device.

Receiving the output limiting information, the output limiting device limits output of a design resource depending upon the received output limiting information.

Due to this, because design resource output is limited depending upon the output limiting information, it is possible to obtain an effect that the mode of output limitation can be set by a setting at the data authentication apparatus side.

Here, the output limiting device may be provided on the output apparatus, the data authentication apparatus or other apparatus. Where the output limiting device is provided on the output apparatus, it may be realized as a part of design resource output device. This is true for the ensuing output apparatus of exemplary embodiment 22 and the design resource output program of exemplary embodiment 38.

Furthermore, a license-authentication functioned output system of exemplary embodiments 2 to 11, the output apparatus is any one of a printer, a display and a raster image processor for conversion processing of from document data to output data.

With this configuration, in the case of a printer or display, when the output apparatus receives license information, the design resource output device prints or display the design resource within a use-permitted scope depending upon the received use-permitting information and inputted design resource data.

Due to this, because the design resource is printed or displayed within a use-permitted scope depending upon the use-permitting information, it is possible to obtain an effect that design resource printing or display can be limited by a setting of use-permitting information.

Meanwhile, in the case of a raster image processor, when the output apparatus receives use-permitting information, the design resource output device makes a conversion process into output data within a use-permitted scope depending upon the received use-permitting information and inputted document data.

Due to this, because the document data is conversion-processed within the use-permitted scope depending upon the use-permitting information, it is possible to obtain an effect that conversion process of document data can be limited by a setting of use-permitting information.

Here, the raster image processor generally refers to the apparatus for processing design resource data into a form suited for the mechanism of an output device, e.g., process of converting design resource data to print into output data corresponding to the printing mechanism of a printer, outputting, as pixel data, design resource data of an object for display on the screen according to the order of scanning the screen, or so. This is true for the output apparatus of exemplary embodiment 23 and the license authentication output method of exemplary embodiment 55.

Meanwhile, in order to address or achieve the foregoing object, a output apparatus of exemplary embodiment 13 is a output apparatus to output a design resource and limiting output of the design resource depending upon design resource data, the output apparatus includes:
a design resource data input device to input the design resource data to which authentication information is placed in correspondence;
a subject identification information input device to input subject identification information identifying a subject of use of the design resource data;
an authentication request transmitting device to send, together with an authentication request, authentication information placed in correspondence to the design resource data inputted by the design resource data input device and subject identification information inputted by the subject identification information input device to the data authentication apparatus; and
design resource output device to output the design resource depending upon the design resource data.

The design resource output device is adapted, when the relevant output apparatus received use-permitting information defining a use-permitted scope of the design resource data, to output the design resource within a use-permitted scope depending upon the received use-permitting information and the design resource data inputted by the design resource data input device.

This configuration provides an operation equivalent to that of the output apparatus of exemplary embodiment 2. Accordingly, it is possible to obtain an effect equivalent to that of the license-authentication functioned output system of exemplary embodiment 2.

Furthermore, a output apparatus of exemplary embodiment 14 is a output apparatus according to exemplary embodiment 13, including a data confirming information generating device to generate data confirming information to confirm a content of the relevant design resource data depending upon design resource data inputted by the design resource data input device.

The authentication request transmitting device is adapted to send, together with the authentication request, the authentication information, the subject identification information and the data confirming information generated by the data confirming information generating device to the data authentication apparatus.

This configuration provides an operation equivalent to that of the output apparatus of exemplary embodiment 3. Accordingly, it is possible to obtain an effect equivalent to that of the license-authentication functioned output system of exemplary embodiment 3.

Furthermore, a output apparatus of exemplary embodiment 15 is a output apparatus according to any one of exemplary embodiments 13 and 14, inquiry about authentication is made to a particular one of the data authentication apparatuses in plurality.

This configuration provides an operation equivalent to that of the output apparatus of exemplary embodiment 4. Accordingly, it is possible to obtain an effect equivalent to that of the license-authentication functioned output system of exemplary embodiment 4.

Furthermore, a output apparatus of exemplary embodiment 16 is a output apparatus according to any one of exemplary embodiments 13 and 14, including an apparatus-authenticating device to authenticate a reliability of the data authentication apparatus, and being adapted to make an inquiry about authentication to one of the data authentication apparatuses authenticated by the apparatus-authenticating device.

This configuration provides an operation equivalent to that of the output apparatus of exemplary embodiment 5. Accordingly, it is possible to obtain an effect equivalent to that of the license-authentication functioned output system of exemplary embodiment 5.

Furthermore, a output apparatus of exemplary embodiment 17 is a output apparatus according to any one of exemplary embodiments 13 to 16, the subject identification information is apparatus identification information identifying the relevant apparatus.

This configuration provides an operation equivalent to that of the output apparatus of exemplary embodiment 6. Accordingly, it is possible to obtain an effect equivalent to that of the license-authentication functioned output system of exemplary embodiment 6.

Furthermore, a output apparatus of exemplary embodiment 18 is a output apparatus according to any one of exemplary embodiments 13 to 16, the subject identification information is user identification information identifying a user who is to use the design resource data.

This configuration provides an operation equivalent to that of the output apparatus of exemplary embodiment 7. Accordingly, it is possible to obtain an effect equivalent to that of the license-authentication functioned output system of exemplary embodiment 7.

Furthermore, a output apparatus of exemplary embodiment 19 is a output apparatus according to any one of exemplary embodiments 13 to 18, wherein the design resource output device is adapted to decide depending upon the received use-permitting information whether or not the use is outside a use-permitted scope, and to limit output of the design resource data inputted by the design resource data input device when it is decided that the use is outside a use-permitted scope.

This configuration provides an operation equivalent to that of the output apparatus of exemplary embodiment 8. Accordingly, it is possible to obtain an effect equivalent to that of the license-authentication functioned output system of exemplary embodiment 8.

Furthermore, a output apparatus of exemplary embodiment 20 is a output apparatus according to any one of exemplary embodiments 13 to 18, the design resource output device is adapted to decide depending upon the received use-permitting information whether or not the use is outside a use-permitted scope, and output the design resource by a predetermined output limiting process depending upon the design resource data inputted by the design resource data input device when it is decided that the use is outside a use-permitted scope.

This configuration provides an operation equivalent to that of the output apparatus of exemplary embodiment 9. Accordingly, it is possible to obtain an effect equivalent to that of the license-authentication functioned output system of exemplary embodiment 9.

Furthermore, a output apparatus of exemplary embodiment 21 is a output apparatus according to any one of exemplary embodiments 13 to 18, the design resource output device is adapted to decide depending upon the received use-permitting information whether or not the use is outside a use-permitted scope, and to limit output of the design resource data inputted by the design resource data input device and another one of design resource data to be outputted together with the relevant design resource data when it is decided that the use is outside a use-permitted scope.

This configuration provides an operation equivalent to that of the output apparatus of exemplary embodiment 10. Accordingly, it is possible to obtain an effect equivalent to that of the license-authentication functioned output system of exemplary embodiment 10.

Furthermore, a output apparatus of exemplary embodiment 22 is a output apparatus according to any one of exemplary embodiments 13 to 21, including output limiting device to limit output of the design resource,
the output limiting device is adapted to limit output of the design resource depending upon the received output limiting information when the relevant output apparatus received output limiting information defining an output limiting way of the design resource data.

This configuration provides an operation equivalent to that of the output apparatus of exemplary embodiment 11. Accordingly, it is possible to obtain an effect equivalent to that of the license-authentication functioned output system of exemplary embodiment 11.

Furthermore, a output apparatus of exemplary embodiment 23 is a output apparatus according to any one of exemplary embodiments 13 to 22, any one of a printer, a display and a raster image processor for conversion processing of document data to output data.

This configuration provides an operation equivalent to that of the output apparatus of exemplary embodiment 12. Accordingly, it is possible to obtain an effect equivalent to that of the license-authentication functioned output system of the exemplary embodiment 12.

Meanwhile, in order to achieve the foregoing object, a data authentication apparatus of the exemplary embodiment 24 is a data authentication apparatus to authenticate a use of design resource data, the data authentication apparatus including:
a license information storing device to store license information including use-permitting information defining a use-permitted scope of the design resource data and subject identification information identifying a subject of use of the design resource data, by a correspondence to authentication information;
an authentication request receiving device to receive the authentication information and the subject identification information, together with an authentication request;
a license information search device to search through the license information storing device on the basis of the authentication information received by the authentication request receiving device and reading out license information concerned; and
a data authentication device to authenticate a use of the design resource data depending upon the license information read out by the license information search device.

The data authentication device is adapted to decide whether or not the subject identification information received by the authentication request receiving device is included in the license information read out by the license information search device, and send to the output apparatus use-permitting information included in the license information read out by the license information search device when it is decided that the subject identification information is included.

This configuration provides an operation equivalent to that of the data authentication apparatus of the exemplary embodiment 2. Accordingly, it is possible to obtain an effect equivalent to that of the license-authentication functioned output system of exemplary embodiment 2.

Furthermore, a data authentication apparatus of exemplary embodiment 25 is a data authentication apparatus according to exemplary embodiment 24, the license information includes data confirming information to confirm a content of the design resource data,
the authentication request receiving device being adapted to receive the authentication information, the subject identification information and the data confirming information, together with the authentication request.

The data authentication device further deciding whether or not a predetermined relationship is satisfied by the data confirming information received by the authentication request receiving device and the data confirming information included in the license information read out by the license information search device, and sending the use-permitting information included in the license information read out by the license information search device to the output apparatus when it is decided that the predetermined relationship is satisfied and that the subject identification information is included in the license information.

This configuration provides an operation equivalent to that of the data authentication apparatus of exemplary embodiment 3. Accordingly, it is possible to obtain an effect equivalent to that of the license-authentication functioned output system of exemplary embodiment 3.

Furthermore, a data authentication apparatus of exemplary embodiment 26 is a data authentication apparatus according to any one of exemplary embodiments 24 and 25, the subject identification information is apparatus identification information identifying the output apparatus.

This configuration provides an operation equivalent to that of the data authentication apparatus of exemplary embodiment 6. Accordingly, it is possible to obtain an effect equivalent to that of the license-authentication functioned output system of exemplary embodiment 6.

Furthermore, a data authentication apparatus of exemplary embodiment 27 is a data authentication apparatus according to any one of exemplary embodiments 24 and 25, the subject identification information is user identification information identifying a user who is to use the design resource data.

This configuration provides an operation equivalent to that of the data authentication apparatus of exemplary embodiment 7. Accordingly, it is possible to obtain an effect equivalent to that of the license-authentication functioned output system of exemplary embodiment 7.

Furthermore, a data authentication apparatus of exemplary embodiment 28 is a data authentication apparatus according to any one of exemplary embodiments 24 to 27, the license information includes output limiting information defining an output limiting way of the design resource data.

The data authentication is adapted to decide whether or not the subject identification information received by the authentication request receiving device is included in the license information read out by the license information search device, and send to the output apparatus output limiting information included in the license information read out by the license information search device when it is decided that the subject identification information is not included.

This configuration provides an operation equivalent to that of the data authentication apparatus of exemplary embodiment 11. Accordingly, it is possible to obtain an effect equivalent to that of the license-authentication functioned output system of exemplary embodiment 11.

Meanwhile, in order to address or achieve the foregoing object, a design resource output program of exemplary embodiment 29 is a design resource output program to output a design resource and limiting to output the design resource depending upon design resource data, the design resource output program including a program for a computer to execute a process including:
inputting the design resource data to which authentication information is placed in correspondence;
inputting subject identification information identifying a subject of use of the design resource data;
sending, together with an authentication request, authentication information placed in correspondence to the design resource data inputted by the design resource data input and subject identification information inputted by the subject identification information input to the data authentication apparatus; and
outputting the design resource depending upon the design resource data.

The design resource output is adapted to output the design resource within a use-permitted scope depending upon the received use-permitting information and the design resource data inputted by the design resource data input when the computer received use-permitting information defining a use-permitted scope of the design resource data.

With this configuration, in case the computer reads out the program and executes a process according to the read-out program, obtained is an operation and effect equivalent to that of the output apparatus of exemplary embodiment 13.

Furthermore, a design resource output program of exemplary embodiment 30 is a design resource output program according to exemplary embodiment 29, the design resource output program including a program for the computer to execute a process including generating data confirming information to confirm a content of the design resource data depending upon the design resource data inputted by the design resource data input,
adapting to send, together with the authentication request, the authentication information, the subject identification information and the data confirming information generated by the data confirming information generating to the data authentication apparatus.

With this configuration, in case the computer reads out the program and executes a process according to the read-out program, obtained is an operation and effect equivalent to that of the output apparatus of exemplary embodiment 14.

Furthermore, a design resource output program of exemplary embodiment 31 is a design resource output program according to any one of exemplary embodiments 29 and 30, the design resource output program including a program to the computer to execute a process of making an inquiry about authentication to a particular one of the data authentication apparatuses in plurality.

With this configuration, in case the computer reads out the program and executes a process according to the read-out program, obtained is an operation and effect equivalent to that of the output apparatus of exemplary embodiment 15.

Furthermore, a design resource output program of exemplary embodiment 32 is a design resource output program according to any one of the exemplary embodiments 29 and 30, the design resource output program including a program for the computer to execute a process including authenticating a reliability of the data authentication apparatus, and a process of making an inquiry about authentication to one of the data authentication apparatuses authenticated by the apparatus-authenticating.

With this configuration, in case the computer reads out the program and executes a process according to the read-out program, obtained is an operation and effect equivalent to that of the output apparatus of exemplary embodiment 16.

Furthermore, a design resource output program of exemplary embodiment 33 is a design resource output program according to any one of the exemplary embodiments 29 to 32, the subject identification information is apparatus identification information identifying the relevant apparatus.

With this configuration, in case the computer reads out the program and executes a process according to the read-out program, obtained is an operation and effect equivalent to that of the output apparatus of exemplary embodiment 17.

Furthermore, a design resource output program of exemplary embodiment 34 is a design resource output program according to any one of exemplary embodiments 29 to 32, the subject identification information is user identification information identifying a user who is to use the design resource data.

With this configuration, in case the computer reads out the program and executes a process according to the read-out program, obtained is an operation and effect equivalent to that of the output apparatus of exemplary embodiment 18.

Furthermore, a design resource output program of exemplary embodiment 35 is a design resource output program according to any one of exemplary embodiments 29 to 34, the design resource output is to decide depending upon the received use-permitting information whether or not the use is outside a use-permitted scope, and limit to output the design resource data inputted by the design resource data input when it is decided that the use is outside a use-permitted scope.

With this configuration, in case the computer reads out the program and executes a process according to the read-out program, obtained is an operation and effect equivalent to that of the output apparatus of exemplary embodiment 19.

Furthermore, a design resource output program of exemplary embodiment 36 is a design resource output program according to any one of exemplary embodiments 29 to 34, the design resource output is to decide depending upon the received use-permitting information whether or not the use is outside a use-permitted scope, and output the design resource by a predetermined output limiting process depending upon the design resource data inputted by the design resource data input step, when it is decided that the use is outside a use-permitted scope.

With this configuration, in case the computer reads out the program and executes a process according to the read-out program, obtained is an operation and effect equivalent to that of the output apparatus of exemplary embodiment 20.

Furthermore, a design resource output program of exemplary embodiment 37 is a output apparatus according to any one of exemplary embodiments 29 to 34, the design resource output is to decide depending upon the received use-permitting information whether or not the use is outside a use-permitted scope, and limit to output the design resource data inputted by the design resource data input and another one of design resource data to be outputted together with the relevant design resource data when it is decided that the use is outside a use-permitted scope.

With this configuration, in case the computer reads out the program and executes a process according to the read-out program, obtained is an operation and effect equivalent to that of the output apparatus of exemplary embodiment 21.

Furthermore, a design resource output program of exemplary embodiment 38 is a design resource output program according to any one of exemplary embodiments 29 to 37, the design resource output program including a program for the computer to execute a process including limiting to output the design resource,
the output limiting for limiting to output the design resource depending upon the received output limiting information when the computer received output limiting information defining an output limiting way of the design resource data.

With this configuration, in case the computer reads out the program and executes a process according to the read-out program, obtained is an operation and effect equivalent to that of the output apparatus of exemplary embodiment 22.

Meanwhile, in order to address or achieve the foregoing object, a data-authenticating program in exemplary embodiment 39 is a data-authenticating program to authenticate the use of design resource data, the data-authenticating program including a program for a computer capable of making use of license information storing device to store license information including use-permitting information defining a use-permitted scope of the design resource data and subject identification information identifying a subject of use of the design resource data by a correspondence to authentication information, to execute:
receiving the authentication information and the subject identification information, together with an authentication request;
searching through the license information storing device on the basis of the authentication information received in the authentication request receiving and reading out license information concerned; and
authenticating the use of the design resource data depending upon the license information read out in the license information search;

The data authentication is to decide whether or not the subject identification information received in the authentication request receiving is included in the license information read out in the license information search, and send to the output apparatus use-permitting information included in the license information read out in the license information search when it is decided that the subject identification information is included.

With this configuration, in case the computer reads out the program and executes a process according to the read-out program, obtained is an operation and effect equivalent to that of the data authentication apparatus of exemplary embodiment 24.

Furthermore, a data authentication program of exemplary embodiment 40 is a data authentication program according to exemplary embodiment 39, the license information including data confirming information for confirming a content of the design resource data.

The authentication request receiving to receive the authentication information, the subject identification information and the data confirming information, together with the authentication request.

The data authentication being further to decide whether or not a predetermined relationship is satisfied by the data confirming information received in the authentication request receiving and the data confirming information included in the license information read out in the license information search, and to send the use-permitting information included in the license information read out in the license information search to the output apparatus when it is decided that the predetermined relationship is satisfied and that the subject identification information is included in the license information.

With this configuration, in case the computer reads out the program and executes a process according to the read-out program, obtained is an operation and effect equivalent to that of the data authentication apparatus of exemplary embodiment 25.

Furthermore, a data authentication program of exemplary embodiment 41 is a data authentication program according to any one of exemplary embodiments 39 and 40, the subject identification information is apparatus identification information identifying the output apparatus.

With this configuration, in case the computer reads out the program and executes a process according to the read-out program, obtained is an operation and effect equivalent to that of the data authentication apparatus of exemplary embodiment 26.

Furthermore, a data authentication program of the exemplary embodiment 42 is a data authentication program according to any one of exemplary embodiments 30 and 40, the subject identification information is user identification information identifying a user who is to use the design resource data.

With this configuration, in case the computer reads out the program and executes a process according to the read-out program, obtained is an operation and effect equivalent to that of the data authentication apparatus of exemplary embodiment 27.

Furthermore, a data authentication program of exemplary embodiment 43 is a data authentication program according to any one of the exemplary embodiments 39 to 42, the license information includes output limiting information defining an output limiting way of the design resource data.

The data authentication being to decide whether or not the subject identification information received in the authentication request receiving is included in the license information read out in the license information search, and send to the output apparatus output limiting information included in the license information read out in the license information search when it is decided that the subject identification information is not included.

With this configuration, in case the computer reads out the program and executes a process according to the read-out program, obtained is an operation and effect equivalent to that of the data authentication apparatus of exemplary embodiment 28.

Meanwhile, in order to address or achieve the foregoing object, a license authentication output method of exemplary embodiment 44 is a license authentication output method to output a design resource and limiting to output the design resource depending upon design resource data, the license authentication output method including:
inputting the design resource data to which authentication information is placed in correspondence;
inputting the subject identification information identifying a subject of use of the design resource data;
searching through the license information storing device storing license information including the use-permitting information defining a use-permitted scope of the design resource data and the subject identification information by a correspondence to authentication information on the basis of the authentication information placed in correspondence to the design resource data inputted in the design resource data input and reading out license information concerned;
deciding whether or not the subject identification information inputted in the subject identification information input is included in the license information read out in the license information search; and
outputting the design resource within a use-permitted scope depending upon the use-permitting information included in the license information read out in the license information search and the design resource data inputted by the design resource data input when the data authentication decides that the subject identification information is included.

This can obtain an effect equivalent to that of the license-authentication functioned output system of exemplary embodiment 1.

Here, the design resource data input provides that design resource data is to be inputted, for example, to acquire design resource data, receive design resource data or read out design resource data out of a storage device or the like.

Meanwhile, the subject identification input provides that subject identification information is to be inputted, for example, to acquire subject identification information, receive subject identification information or read out subject identification information out of storage device or the like.

Furthermore, a license authentication output method of exemplary embodiment 45 is a license authentication output method that communicatably connected are a output apparatus to output a design resource depending upon design resource data and a data authentication apparatus to authenticate a use of the design resource data, thereby limiting to output the design resource, the license authentication output method including:
for the output apparatus,
inputting the design resource data to which authentication information is placed in correspondence;
inputting subject identification information identifying a subject of use of the design resource data; and
sending, together with an authentication request, authentication information placed in correspondence to the design resource data inputted in the design resource data input and the subject identification information inputted in the subject identification information input to the data authentication apparatus.

For the data authentication apparatus,
receiving the authentication information and the subject identification information, together with the authentication request;
searching through the license information storing device storing license information including use-permitting information defining a use-permitted scope of the design resource data and the subject identification information by a correspondence, to authentication information on the basis of the authentication information received in the authentication request receiving; and
deciding whether or not the subject identification information received in the authentication request receiving is included in the license information read out by the license information search, and sending the use-permitting information included in the license information read out by the license information search to the output apparatus when it is decided that the subject identification information is included.

For the design resource output device outputting the design resource within a use-permitted scope depending upon the use-permitting information received and the design resource data inputted in the design resource data input device when the output apparatus received the use-permitting information.

This can obtain an effect equivalent to that of the license-authentication functioned output system of exemplary embodiment 2.

Furthermore, a license authentication output method of exemplary embodiment 45 is a license authentication output method according to exemplary embodiment 45, the license information includes data confirming information to confirm a content of the design resource data. The method including for the output apparatus,
generating data confirming information to confirm a content of the design resource data depending upon the design resource data inputted by the design resource data input,
the authentication request transmitting being to send the authentication information, the subject identification information and the data confirming information generated in the data confirming information generating, together with the authentication request, to the data authentication apparatus,
the authentication request receiving being to receive, together with the authentication request, the authentication information, the subject identification information and the data confirming information,
the data authentication being further to decide whether or not a predetermined relationship is satisfied by the data confirming information received in the authentication request receiving and the data confirming information included in the license information read out in the license information search, and sending the use-permitting information included in the license information read out in the license information search to the output apparatus when it is decided that the predetermined relationship is satisfied and that the subject identification information is included in the license information.

This can obtain an effect equivalent to that of the license-authentication functioned output system of exemplary embodiment 3.

Furthermore, a license authentication output method of exemplary embodiment 47 is a license authentication output method according to any one of exemplary embodiments 45 and 46, the output apparatus and the data authentication apparatuses in plurality are communicatably connected together. The method includes for the output apparatus,
making an inquiry about authentication to a particular one of the data authentication apparatuses in plurality.

This can obtain an effect equivalent to that of the license-authentication functioned output system of exemplary embodiment 4.

Furthermore, a license authentication output method of exemplary embodiment 47 is a license authentication output method according to any one of exemplary embodiments 45 and 46, the output apparatus and the data authentication apparatuses in plurality are communicatably connected together. The method including for the output apparatus,
authenticating a reliability of the data authentication apparatus, to make an inquiry about authentication to one of the data authentication apparatuses authenticated by the apparatus-authenticating.

This can obtain an effect equivalent to that of the license-authentication functioned output system of the exemplary embodiment 5.

Furthermore, a license authentication output method of exemplary embodiment 49 is a license authentication output method according to any one of exemplary embodiments 45 to 48, the subject identification information is apparatus identification information to identify the output apparatus.

This can obtain an effect equivalent to that of the license-authentication functioned output system of exemplary embodiment 6.

Furthermore, a license authentication output method of exemplary embodiment 50 is a license authentication output method according to any one of exemplary embodiments 45 to 48, the subject identification information is user identification information identifying a user who is to use the design resource data.

This can obtain an effect equivalent to that of the license-authentication functioned output system of exemplary embodiment 7.

Furthermore, a license authentication output method of exemplary embodiment 51 is a license authentication output method according to any one of exemplary embodiments 45 to 50, the design resource output is to decide depending upon the received use-permitting information whether or not the use is outside a use-permitted scope, and limit to output the design resource data inputted by the design resource data input when it is decided that the use is outside a use-permitted scope.

This can obtain an effect equivalent to that of the license-authentication functioned output system of exemplary embodiment 8.

Furthermore, a license authentication output method of exemplary embodiment 52 is a license authentication output method according to any one of exemplary embodiments 45 to 50, the design resource output is to decide depending upon the received use-permitting information whether or not the use is outside a use-permitted scope, and output the design resource by a predetermined output limiting process depending upon the design resource data inputted in the design resource data input when it is decided that the use is outside a use-permitted scope.

This can obtain an effect equivalent to that of the license-authentication functioned output system of exemplary embodiment 9.

Furthermore, a license authentication output method of exemplary embodiment 53 is a license authentication output method according to any one of exemplary embodiments 45 to 50, the design resource output is to decide depending upon the received use-permitting information whether or not the use is outside a use-permitted scope, and limit to output the design resource data inputted in the design resource data input and another one of design resource data to be outputted together with the design resource data when it is decided that the use is outside a use-permitted scope.

This can obtain an effect equivalent to that of the license-authentication functioned output system of exemplary embodiment 10.

Furthermore, a license authentication output method of exemplary embodiment 54 is a license authentication output method according to any one of exemplary embodiments 45 to 53, the license information includes output limiting information defining an output limiting way of the design resource data.

The method including limiting output of the design resource,
the data authentication being to decide whether or not the subject identification information received by the authentication request receiving is included in the license information read out in the license information search, and send to the output apparatus output limiting information included in the license information read out in the license information search when it is decided that the subject identification information is not included,
limiting to output the design resource depending upon the received output limiting information when the output limiting information is received.

This can obtain an effect equivalent to that of the license-authentication functioned output system of exemplary embodiment 11.

Furthermore, a license authentication output method of exemplary embodiment 55 is a license authentication output method according to any one of exemplary embodiments 45 to 54, the output apparatus is any one of a printer, a display and a raster image processor for conversion processing of from document data to output data.

This can obtain an effect equivalent to that of the license-authentication functioned output system of exemplary embodiment 12.

### BRIEF DESCRIPTION OF THE DRAWINGS

FIG. 1 is a schematic functional block diagram showing the functional outline of a network system to which the present invention is applied;

FIG. 2 is a schematic block diagram showing a configuration of a printer 200;

FIG. 3 is a flowchart showing a print control process;

FIG. 4 is a schematic block diagram showing a configuration of a data authentication server 300;

FIG. 5 is a flowchart showing a data authentication process;

FIG. 6 is a schematic figure showing a print result where authentication is obtained;

FIG. 7 is a schematic figure showing a print result where authentication is not obtained;

FIG. 8 is a schematic figure showing a print result where authentication is not obtained;

FIG. 9 is a flowchart showing a print control process;

FIG. 10 is a flowchart showing a server-key providing process;

FIG. 11 is a block diagram showing a configuration of a game machine 400; and

FIG. 12 is a schematic figure showing a storage medium and its data structure.

### DETAILED DESCRIPTION OF PREFERRED EMBODIMENTS

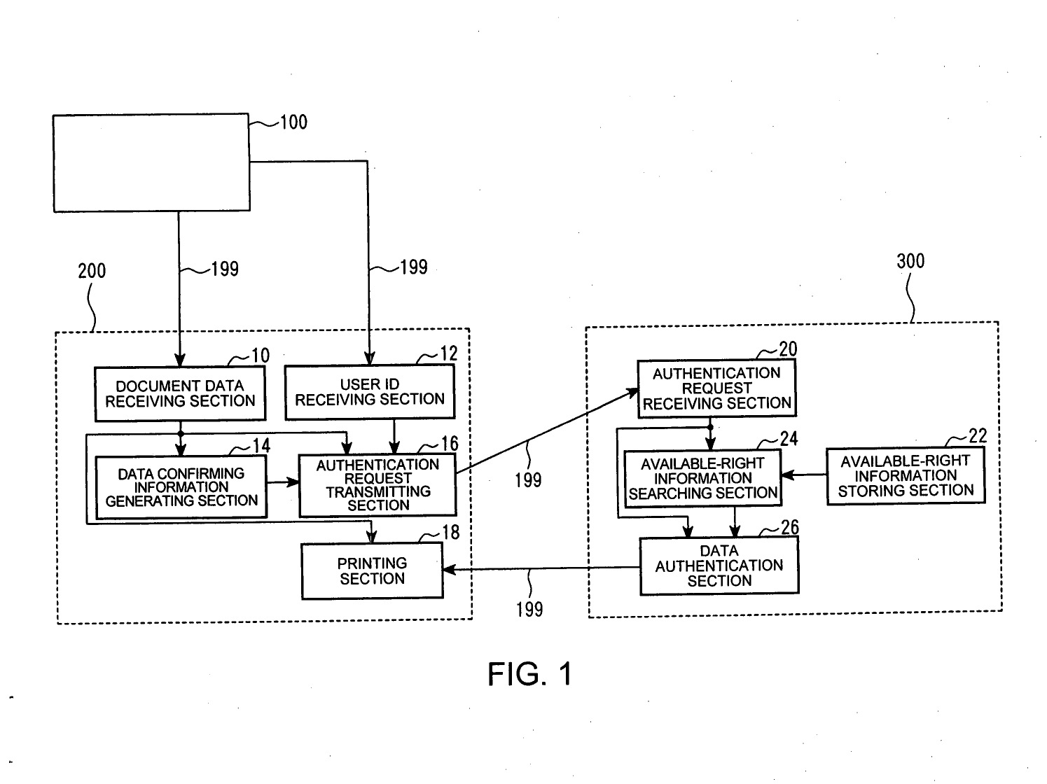

Referring to the drawings, a first exemplary embodiment of the present invention will now be explained. FIGS. 1 to 8 are figures showing a first exemplary embodiment of a license-authentication functioned output system, output apparatus, data authentication apparatus, design resource output program, data authentication program and license authentication output method according to the present invention.

The first exemplary embodiment is an application of the license-authentication functioned output system, output apparatus, data authentication apparatus, design resource output program, data authentication program and license authentication output method of exemplary embodiments of the present invention, to a case of limiting printing of a document by a printer 200, as shown in FIG. 1.

Referring to FIG. 1, explanation is first made in detail on a network system to which exemplary embodiments of the invention is applied.

FIG. 1 is a schematic functional block diagram showing a functional outline of a network system to which exemplary embodiments of the invention are applied.

The Internet 199 is connected with a user terminal unit 100 serving for use by the user, a printer 200 to print a document depending upon document data, and a data authentication server 300 to authenticate a use of document data, as shown in FIG. 1. Note that, although the user terminal unit 100, the printer 200 and the data authentication server 300 are shown only one per each in order for easy understanding of the invention, there are actually a multiplicity of user terminals 100, printers 200 and data authentication servers 300 that are in connection to the Internet 199.

The user terminal unit 100, when printing out a document, sends document data as a subject of printing and user ID currently in use, together with a print request, to the printer 200. Here, document data includes one or more document data and image data (hereinafter, referred to as design resource data) while design resource data each includes the authentication information required for authentication at the data authentication server 300.

The printer 200 is configured, as shown in FIG. 1, with a document-data receiving section 10 to receive document data, a user-ID receiving section 12 to receive a user ID, a data-confirming information generating section 14 to genereate data-confirming information depending upon design resource data, an authentication-request transmitting section 16 to send authentication information, user ID and data-confirming information, together with an authentication request, to the data authentication server 300, and a printing section 18 for printing a document depending upon document data.

The data-confirming information generating section 14 generates data-confirming information to confirm the content of design resource data depending upon the design resource data included in the document data received by the document-data receiving section 10.

The authentication-request transmitting section 16 sends, to the data authentication server 300, the authentication information of the design resource data included in the document data received by the document-data receiving section 10, the user ID received by the user-ID receiving section 12 and the data-confirming information generated by the data-confirming information generating section 14, together with an authentication request.

The printing section 18, when receiving use-permitting information defining a use-permitted scope of design resource data, prints characters or an image (hereinafter, referred to as a design resource) in a use-permitted scope, depending upon the received use-permitting information and the design resource data included in the document data received by the document-data receiving section 10. Meanwhile, when receiving output-limitation information defining the way to limit the output of design resource data, design resource printing is limited depending upon the received output-limiting information.

The data authentication server 300 is configured, as shown in FIG. 1, with an authentication-request receiving section 20 to receive, together with an authentication request, authentication information and user ID and data-confirming information, a license information storing section 22 storing, by a correspondence to authentication information, license information including use-permitting information, output-limiting information, user ID and data-confirming information, a license information search section 24 to search through the license information storing section 22 on the basis of the authentication information received by the authentication-request receiving section 20 and reading out license information concerned, and a data authentication section 26 to authenticate a use of design resource data depending upon the license information read out by the license information search section 24.

The data authentication section 26 decides whether or not there is an agreement between the data-confirming information received by the authentication-request receiving section 20 and the data-confirming information included in the license information read out by the license information search section 24. When an agreement of data-confirming information is decided, it is decided whether or not the user ID as received by the authentication-request receiving section 20 is included in the license information read out by the license information search section 24. When it is decided that the user ID is included, sent to the printer 200 is the use-permitting information included in the license information read out by the license information search section 24. Meanwhile, when it is decided that the data-confirming information is not in agreement or that the user ID is not included, to the printer 200 is the output-limiting information included in the license information read out by the license information search section 24.

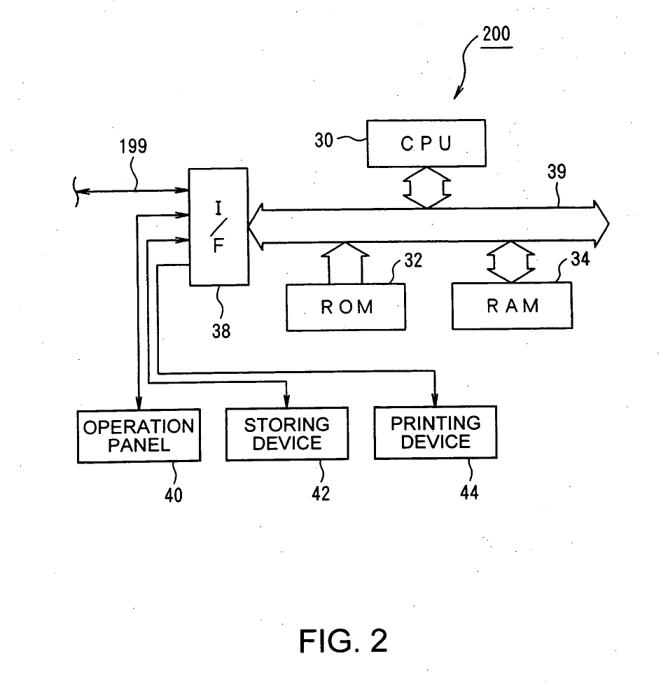

Referring to FIG. 2, explanation is now made on the configuration of the printer 200.

FIG. 2 is a schematic block diagram showing a configuration of the printer 200.

The printer 200 is configured, as shown in FIG. 2, with a CPU 30 for control of operation and system overall on the basis of a control program, a ROM 32 storing a control program, etc. for the CPU 30 in a predetermined domain, a RAM 34 to store the data read out of the ROM 32 and an operation result required in the operation process of the CPU 30, and an I/F 38 to mediate input/output data from/to the external apparatus. Those are mutually connected to exchange data through a bus 39 as a signal line for data transfer.

The I/F 38 is connected with, as external devices, an operation panel 40 as a human interface made up by a touch panel or the like capable of inputting/outputting and displaying data, a storage device 42 to store, as files, data, tables and so on, a printing device 44 made up by a printhead, a head drive section and other mechanisms needed for printing, and a signal line for connection to the Internet 199.

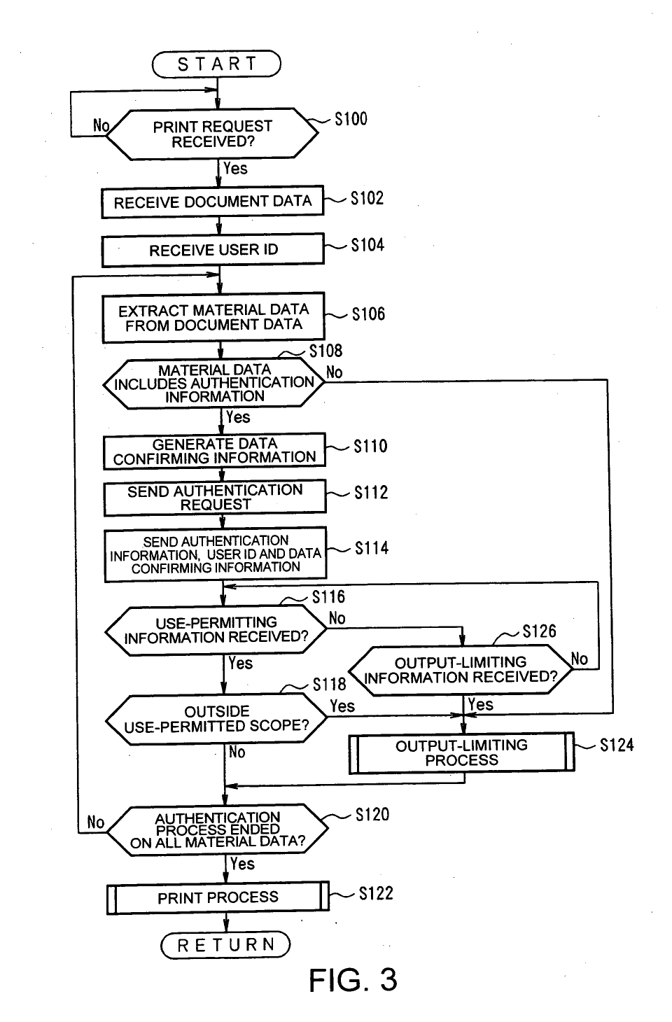

The CPU 30 includes a micro-processing unit (MPU), etc., to start up a predetermined program stored in the ROM 32 at its predetermined domain and carry out a print control process shown in the flowchart of FIG. 3 according to the program.

FIG. 3 is a flowchart showing a print control process.

The print control process is a process to print a document depending upon the document data of from the user terminal unit 100. In case executed in CPU 30, it first moves to step S100 as shown in FIG. 3.

At step S100, it is decided whether or not a print request was received. When it is decided that a print request was received (Yes), the process moves to step S102. When it is decided not so (No), the process waits at the step S100 until a print request is received.

At step S102, document data is received and the process moves to step S104 where a user ID is received and the process moves to step S106.

At step S106, design resource data is extracted out of the document data received, and the process moves to step S108 where it is decided whether or not authentication information is included in the extracted design resource data. When it is decided that authentication information is included in the design resource data (Yes), the process moves to step S110.

At step S110, data-confirming information is generated by a hash function or the like depending upon the extracted design resource data. The process moves to step S112, to send an authentication request to the data authentication server 300. The step moves to step S114, to send the authentication information of the extracted design resource data, the received user ID and the generated data-confirming information to the data authentication server 300. The step moves to step S116.

At step S116, it is decided whether or not use-permitting information was received. When it is decided that use-permitting information was received (Yes), the process moves to step S118, to decide depending upon the received use-permitting information whether or not the use is outside a use-permitted scope. When it is decided that the use is within a use-permitted scope (Yes), the process moves to step S120.

At step S120, it is decided whether or not authentication process was ended by the data authentication server 300 on all the design resource data of the received document data. When it is decided that authentication process was ended on all the design resource data (Yes), the process moves to step S122 where the document is printed by the printing device 44 depending upon the received document data and the design resource data processed for output limiting. Then, the process in series is ended for return to the former process.

Meanwhile, when it is decided at step S120 that authentication process was not ended by the data authentication server 300 on all the design resource data of the received document data (No), the process moves to step S106.

Meanwhile, when it is decided at step S118 that the use is outside the use-permitted scope (Yes), the process moves to step S124 where output limiting process (e.g., mosaic process) is made on the extracted design resource data. Then, the process moves to step S120.

Meanwhile, when it is decided at step S116 that use-permitting information was not received (No), the process moves to step S126 where it is decided whether or not output-limiting information was received. When it is decided that output-limiting information was received (Yes), the process moves to step S124.

Meanwhile, when it is decided at step S126 that output-limiting information was not received (No), the process moves to step S116.

Meanwhile, when it is decided at step S108 that authentication information is not included in the extracted design resource data (No), the process moves to step S124.

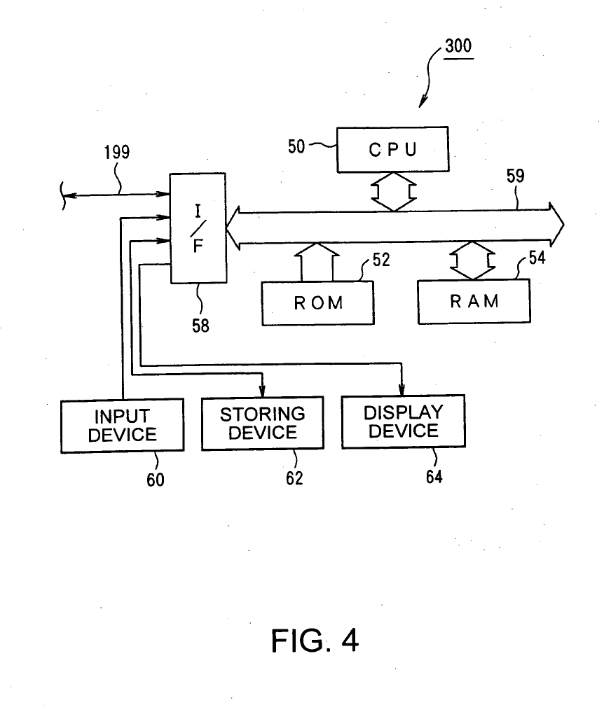

Referring to FIG. 4, explanation is now made on the configuration of the data authentication server 300.

FIG. 4 is a schematic block diagram showing the configuration of the data authentication server 300.

The data authentication server 300 is configured, as shown in FIG. 4, with a CPU 50 for control of operation and system overall depending upon a control program, a ROM 52 storing the control program for the CPU 50 in a predetermined domain, a RAM 54 to store the data read out of the ROM 52 and an operation result required for the operation process of the CPU 50, and an I/F 58 to mediate to input/output data from/to the external apparatus. Those are mutually connected for exchanging data through a bus 59 as a signal line for data transfer.

The I/F 58 is connected with, as external devices, an input device, such as a keyboard or a mouse, as a human interface capable of inputting data, a storage device 62 to store, as files, data, tables and so on, a display device 64 to display a screen depending upon an image signal, and a signal line for connection to the Internet 199.

The storage device 62 is stored with license information register table registered with license information and authentication information by a correspondence on each of design resource data. The license information register table is registered with one record per each of design resource data. Each record is configured including a field registering authentication information, a field registering use-permitting information, a field registering output-limiting information, a field registering a user ID and a field registering data confirming information. Here, a plurality of user IDs can be registered for one of design resource data while the use-permitting information can be registered based on each user ID by a correspondence to a user ID.

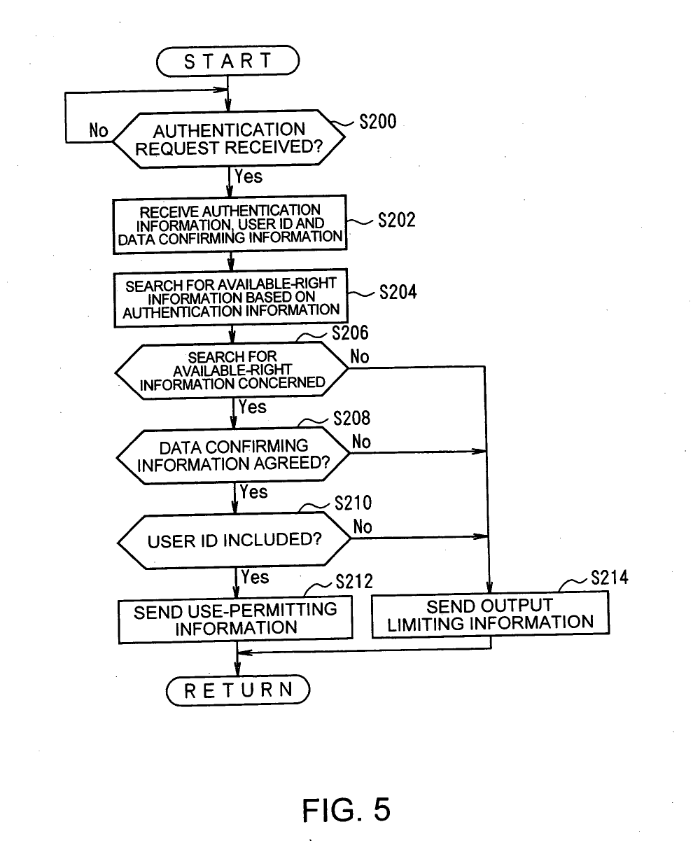

The CPU 50 includes a micro-processing unit (MPU), etc., to start up a predetermined program stored in the ROM 52 at its predetermined domain and carry out a data authentication process shown in the flowchart of FIG. 5 according to the program.

FIG. 5 is a flowchart showing the data authentication process.

The data authentication process is a process to authenticate a use of design resource data. In case it is executed by the CPU 50, the process first moves to step S200 as shown in FIG. 5.

At step S200, it is decided whether or not an authentication request was received. When it is decided that an authentication request was received (Yes), the process moves to step S202. When it is decided not so (No), the process waits at step S200 until an authentication request is received.

At step S202, received are authentication information, user ID and data-confirming information. The process moves to step S204 where the license information register table is searched through based on the received authentication information, to read out license information concerned. The process then moves to step S206.

At step S206, it is decided whether or not license information concerned could be found out by the search. When it is decided that license information concerned was found by the search (Yes), the process moves to step S208.

At step S208, it is decided whether or not there is an agreement between the data-confirming information received and the data-confirming information included in the read-out license information. When it is decided there is an agreement between those of data-confirming information (Yes), the process moves to step S210.

At step S210, it is decided whether or not the user ID received is included in the license information read out. When it is decided that the user ID received is included in the license information read out (Yes), the process moves to step S212 where the use-permitting information included in the license information read out is sent to the printer 200. Thus, the process in series is ended for return to the former process.

Meanwhile, when it is decided at step S210 that the user ID as received is not included in the license information read out (No), the process moves to step S214 where the output-limiting information included in the license information read out is sent to the printer 200. The process in series is ended for return to the former process.

Meanwhile, when it is decided that there is no agreement between the data-confirming information received and the data-confirming information included in the license information read out (No), the process moves to step S214.

Meanwhile, when it is decided at step S206 that license information concerned cannot be searched for (No), the process moves to step S214.

Now explanation is made on the operation of the first exemplary embodiment.

In the case to print a document, the user at the user terminal unit 100 sends document data and his/her own user ID, together with a print request, to the printer 200.

At the printer 200, when the document data and user ID are received together with the print request, design resource data is extracted from the received document data through step S106 and S108. It is decided whether or not the extracted design resource data includes authentication information therein. As a result, if it is decided that authentication information is included, the process passes steps S110-S114 thereby generating data-confirming information depending upon extracted design resource data. Thus, the authentication information of the extracted design resource data, the received user ID and the generated data-confirming information are sent together with an authentication request to the data authentication server 300.

At the data authentication server 300, after receiving the authentication information, user ID and data-confirming information together with the authentication request, the process passes steps S204-S208 whereby the license information register table is searched through depending upon the received authentication information, to read out license information concerned. It is decided whether or not there is an agreement between the data-confirming information received and the data-confirming information included in the license information read out. This decision is to authenticate a fact that the design resource data is free of manipulations. As a result, if it is decided that an agreement between those of data-confirming information is established, it is decided through step S210 whether or not the user ID received is included in the license information read out. This decision is to authenticate a fact the user who is to use the design resource data is an authorized user. As a result, if it is decided that the user ID is included, the use-permitting information included in the read license information is sent to the printer 200 through step S212.

At the printer 200, when use-permitting information is received, it is decided through step S1118 whether or not the use is outside a use-permitted scope depending upon the received use-permitting information. As a result, if it is decided that the use is outside the use-permitted scope, the extracted design resource data is processed for output limitation through step S124. Thus, the design resource data processed of output limitation is used for printing. Contrary to this, when it is decided that the use is within of the use-permitted scope, the extracted design resource data, as it is, is used for printing.

Meanwhile, at the data authentication server 300, when it is decided that the data-confirming information is not in agreement or the user ID is not included, the output-limiting information included in the read-out license information is sent to the printer 200 through step S214.

At the printer 200, when the output-limiting information is received, output-limiting process is made on the extracted design resource data through step S124 thus using design resource data processed of output limitation for printing.

Such authentication process is carried out on all the design resource data included in the document data. After ending the authentication process on all the design resource data, the document is printed through step S122 depending upon the received document data and the design resource data processed of output limitation.

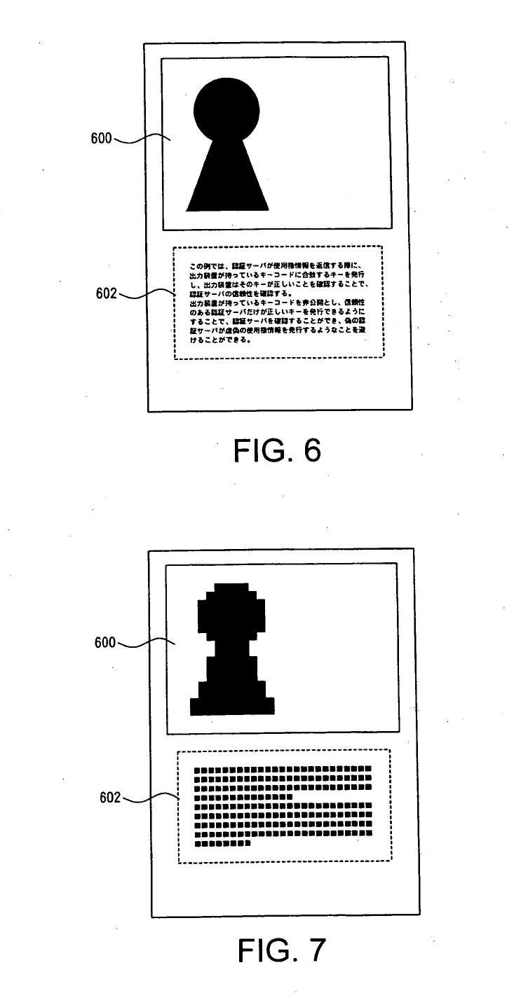

FIG. 6 is a schematic showing a print result in the case an authentication is gained.

In the case an authentication is gained from the data authentication server 300, the design resource data is printed out as it is without undergoing any processing of output limitation, as shown in FIG. 6. In the example of FIG. 6, there are laid out an image 600 and a text 602. Because authentication is gained for the image data and text data from the data authentication server 300, the image 600 and the text 602 are printed as they are.

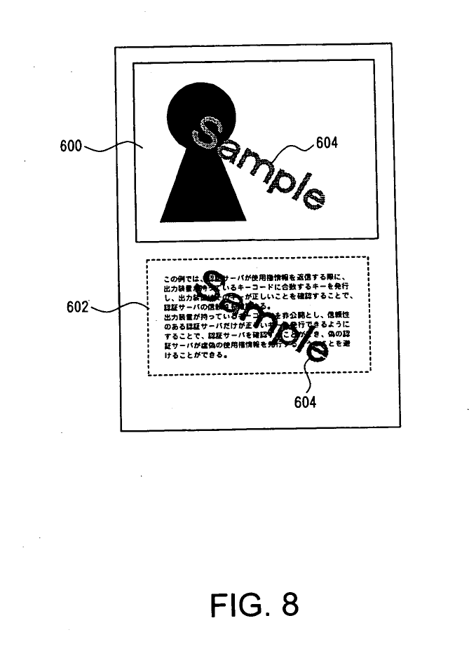

FIGS. 7 and 8 are schematics showing print results not gained with an authentication.

Where no authentication is gained from the data authentication server 300, printing is by processing for output limitation on the design resource data, as shown in FIGS. 7 and 8. In the example of FIG. 7, because no authentication is gained for the image data and character data from the data authentication server 300, the image 600 and character 602 are printed with mosaic processing. Meanwhile, in the example of FIG. 8, the image 600 and characters 602 are printed by superposing a character 604 of “Sample” thereon.

In this manner, in the first exemplary embodiment, the printer 200 receives document data and user ID, to send the design resource-data authentication information and user ID included in the document data, together with an authentication request, to the data authentication server 300. When use-permitting information is received, it prints the design resource within a use-permitted scope depending upon the use-permitting information and design resource data. Meanwhile, the data authentication server 300, when receiving authentication information and user ID, together with an authentication request, searches through the license information register table on the basis of the authentication information and reads out license information concerned, to decide whether or not the user ID received is included in the license information. When it is decided that the user ID is included, the use-permitting information included in the license information is sent to the printer 200.

Because this allows for printing the design resource within a use-permitted scope depending upon the use-permitting information, the design resource can be limited in printing by a setting of use-permitting information. Meanwhile, because the design resource is limited in printing by collaboration with the data authentication server 300, design resource printing can be similarly limited at other printers 200. Accordingly, design resource data can be protected comparatively positively as compared to the related art. Furthermore, for an authorized user, design resource is not limited in printing. Meanwhile, even for the design resource data that cannot be outputted, the design resource data can be printed out by suitably updating the license information. Therefore, user's convenience can be comparatively enhanced and/or improved as compared to the related art. Furthermore, because of the absence of encryption and decryption processes, process load can be relieved as compared to the related art.

Furthermore, in the first exemplary embodiment, the printer 200 generates data-confirming information depending upon design resource data and sends authentication information, user ID and data-confirming information, together with an authentication request, to the data authentication server 300. Meanwhile, the data authentication server 300, when receiving the authentication information, user ID and data-confirming information, together with an authentication request, decides whether or not there is an agreement between the data-confirming information received and the data-confirming information included in the license information read out. When it is decided that an agreement is established and that the user ID is included, the use-permitting information included in the license information is sent to the printer 200.

Due to this, when there is no agreement between the data-confirming information which the printer 200 has generated during printing and the data-confirming information held by the data authentication server 300, design resource is limited in printing. Thus, design resource data can be protected further positively.

Furthermore, in the first exemplary embodiment, license information includes a user ID to identify the user who is to use the design resource data.

This allows for setting use-permitted scope on a user-by-user basis.

Furthermore, in the first exemplary embodiment, the printer 200 decides whether or not the use is outside a use-permitted scope. When it is decided that the use is outside the use-permitted scope, a predetermined process of output limitation is made for the design resource depending upon the design resource data thus carrying out printing.

Due to this, because even an authorized user is limited in printing as a use outside a use-permitted scope, design resource data can be protected further positively.

Furthermore, in the first exemplary embodiment, the data authentication server 300, when it is decided that the user ID received is not included in the license information, sends the output-limiting information included in the license information to the printer 200. The printer 200, when the output-limiting information is received, limits to print the design resource depending upon the received output-limiting information.

Due to this, because the design resource is limited in printing depending upon the output-limiting information, print-limiting mode can be set at the side of data authentication server 300.

In the first exemplary embodiment, user ID corresponds to subject identification information in exemplary embodiment 1 to 3, 7, 11, 13, 14, 18, 24, 25, 27 to 30, 34, 39, 40, 42 to 46, 50 or 54, or user identification information of exemplary embodiment 7, 18, 27, 34, 42 or 50. Meanwhile, the printer 200 corresponds to a output apparatus in the exemplary embodiment 2, 3, 12 to 14, 18 to 20, 22 to 25, 28, 39, 40, 43, 45, 46, 54 or 55 while the document data receiving section 10 and step S102 corresponds to design resource data input device of exemplary embodiment 1 to 3, 8, 9, 13, 14, 19 or 20.

Meanwhile, in the first exemplary embodiment, the step S102 corresponds to a design resource data input of exemplary embodiment 29, 30, 35, 36, 44 to 46, 51 or 52 while the user ID receiving section 12 and step S104 corresponds to subject identification information input device of the exemplary embodiment 1, 2 or 13 while the step S104 corresponds to a subject identification information input of the invention 29, 44 or 45. Meanwhile, the data-confirming information generating section 14 and step S110 corresponds to data-confirming information generating device of exemplary embodiment 3 or 14, the step S110 corresponds to a data-confirming information generating of exemplary embodiment 30 or 46, the authentication-request transmitting section 16 and step S112, S114 corresponds to authentication-request transmitting device of exemplary embodiment 2, 3, 13 or 14.

Meanwhile, in the exemplary embodiment, the steps S112, S114 corresponds to an authentication-request transmitting step of exemplary embodiment 29, 30, 45 or 46 while the printing section 18 and steps S116, S118, S122-S126 corresponds to design resource output device of exemplary embodiment 1, 2, 8, 9, 13, 19 or 20 or to output limiting device of exemplary embodiment 11 or 22. Meanwhile, the steps S116, S118, S122-S126 corresponds to a design resource output step of exemplary embodiment 29, 35, 36, 44, 45, 51 or 52 while the data authentication server 300 corresponds to a data authentication apparatus of exemplary embodiment 2, 3, 13, 14, 24, 25, 27 to 30, 45 or 46.

Meanwhile, in the first exemplary embodiment, the license information storing section 22 and storage device 62 corresponds to license information storing device of exemplary embodiment 1, 2, 24, 39, 44 or 45 while the authentication-request receiving section 20 and steps S200, S202 corresponds to authentication-request receiving device of exemplary embodiment 2, 3, 11, 24, 25 or 28. Meanwhile, the steps S200, S202 corresponds to an authentication-request receiving of exemplary embodiment 39, 40, 43, 45, 46 or 54 while the license information search section 24 and step S204 corresponds to license information search device of exemplary embodiment 1 to 3, 11, 24, 25 or 28.

Meanwhile, in the first exemplary embodiment, the step S204 corresponds to a license information search of the invention 39, 40, 43 to 46 or 54, the data authenticating section 26 and steps S206-S214 corresponds to data authenticating device of exemplary embodiment 1 to 3, 11, 24, 25 or 28, and the steps S206-S214 corresponds to data authenticating of exemplary embodiment 39, 40, 43 to 46 or 54.

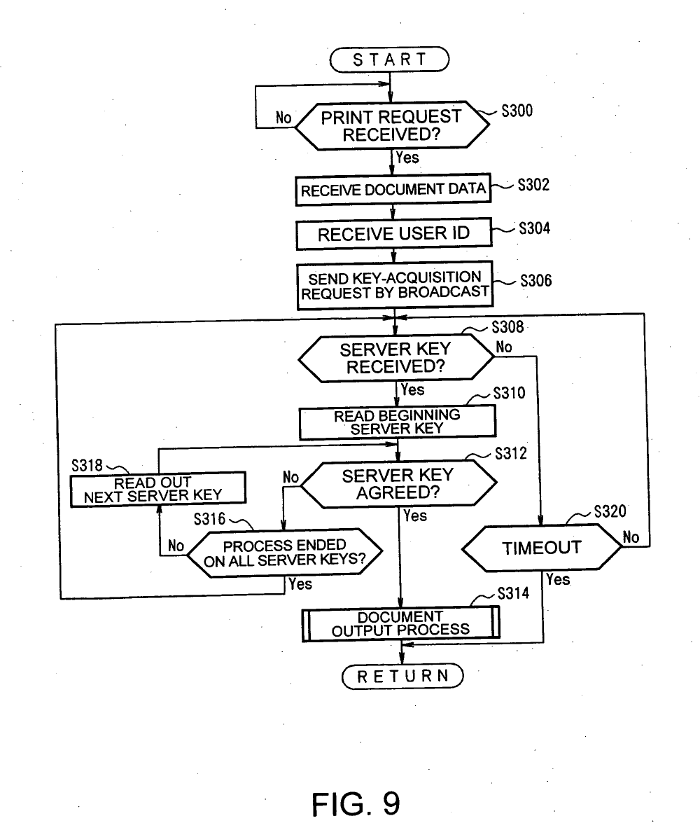

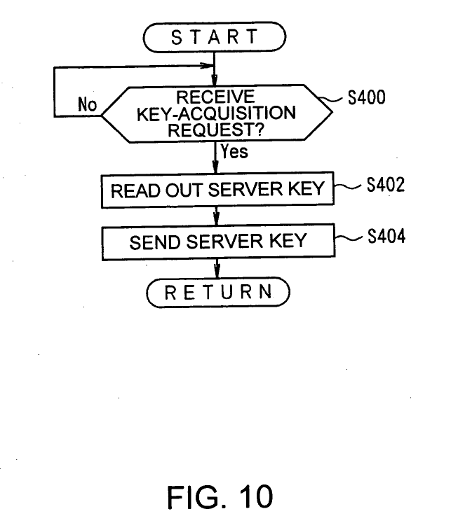

Referring to the drawings, a second exemplary embodiment of the invention will now be explained. FIGS. 9 and 10 are figures showing a second exemplary embodiment of a license-authentication functioned output system, output apparatus, data authentication apparatus, design resource output program, data authentication program and license authentication output method according to the exemplary embodiments of the present invention.

The second exemplary embodiment is an application of the license-authentication functioned output system, output apparatus, data authentication apparatus, design resource output program, data authentication program and license authentication output method of exemplary embodiments of the present invention, to a case to limit document printing at the printer 200, as shown in FIG. 1. This is different from the first exemplary embodiment in that a plurality of data authentication servers 300 are connected to the Internet 199 so that the data authentication server 300 can be utilized after the reliability of the data authentication server 300 is authenticated in the printer 200. In the below, explanation is only on the different point from the first exemplary embodiment, wherein the duplicated elements similar to those of the first exemplary embodiment are attached with the same references, to omit explanation thereof.

The Internet 199 is connected with a printer 200 and a plurality of data authentication servers 300. Each data authentication server 300 is stored with a server key to identify itself uniquely, in its storage device 62. Meanwhile, the printer 200 is stored, in its storage device 42, with a server key of a data authentication server 300 already authenticated in reliability.

Now explanation is made on the configuration of the printer 200.

The CPU 30 starts up a predetermined program stored in a predetermined domain of the ROM 32 and carries out a processing of print control shown in the flowchart in FIG. 9 in place of the print control processing shown in the flowchart of FIG. 3 according to the program.

FIG. 9 is a flowchart showing a processing of print control.

In case a processing of print control is executed by the CPU 30, the process first moves to step S300 as shown in FIG. 9.

At step S300, it is decided whether or not a print request was received. When it is decided that a print request was received (Yes), the process moves to step S302. However, if it is decided not so (No), the process waits in step S300 until a print request is received.

At step S302, document data is received and the process moves to step S304 where a user ID is received and then the process moves to step S306.

At step S306, a key-acquisition request for server key acquisition is sent by broadcast. The process moves to step S308 where it is determined whether or not a server key was received. When it is decided that a server key was received (Yes), the process moves to step S310.

At step S310, read out is a server key at the beginning of the storage device 42. The process moves to step S312, to decide whether or not there is an agreement between the server key received and the server key read out. When it is decided that those server keys are in agreement (Yes), the process moves to step S314.

At step S314, the process is carried out corresponding to the steps S106 to S126 in the flowchart of FIG. 3, to end a series of processes and return to the former process.

Meanwhile, when it is decided at step S312 that there is no agreement between the server key received and the server key read out (No), the process moves to step S316. It is decided whether or not the process of step S312 was ended on all the server keys of the storage device 42. When it is decided that the process was ended on all the server keys (Yes), the process moves to step S308.

Meanwhile, when it is decided at step S316 that the process of step S312 is not ended on all the server keys of the storage device 42, the process moves to step S312, to read out the next server key of the storage device 42. The process moves to step S312.

Meanwhile, when it is decided at step S308 that a server key is not received (No), the process moves to step S320 where it is determined whether or not a predetermined time elapsed from sending a key-acquisition request. When it is decided that a predetermined time elapsed (Yes), the process in series is ended for return the former process.

Meanwhile, when it is decided at step S320 that a predetermined time does not elapsed from sending a key-acquisition request (No), the process moves to step S308.

Now explanation is made on the configuration of the data authentication server 300.

The CPU 50 starts up a predetermined program stored in a predetermined domain of the ROM 52 and carries out a server-key providing process shown in a flowchart of FIG. 10 according to the program.

FIG. 10 is a flowchart showing a server-key providing process.

The server-key providing process is a process to provide a server key in accordance with a key-acquisition request from the printer 200. When the process is executed by the CPU 50, it first moves to step S400 as shown in FIG. 10.

At step S400, it is decided whether or not a key-acquisition request is received. When it is decided that a key-acquisition request is received (Yes), the process moves to step S402. However, when it is decided not so (No), the process waits at step S400 until a key-acquisition request is received.

At step S402, a server key is read out of the storage device 62. The process moves to step S404 where the read-out server key is sent to the printer 200. Thus, the process in series is ended for return to the former process.

Now explanation is made on the operation of the second exemplary embodiment.

In the case to print a document, the user at the user terminal unit 100 sends document data and his/her own user ID, together with a print request, to the printer 200.

At the printer 200, when the document data and user ID are received together with the print request, a key-acquisition request is sent by broadcast through step S306.

At the data authentication server 300, after the key-acquisition request is received, a server key is read out through steps S402 and S403. The read-out server key is sent to the printer 200.

At the printer 200, when the server key is received, it is determined through steps S310-S312, S316 and S318 whether or not the server key received agrees with any of the server keys of the storage device 42. As a result, if it is decided that it agrees with any of the server keys, one of a plurality of data authentication servers 300 corresponding to the server key is decided as one for authentication. By collaboration with the data authentication server 300 for authentication, a document is printed out depending upon the received document data similarly to the first exemplary embodiment.

In this manner, in the second exemplary embodiment, the printer 200 authenticates a reliability of the data authentication server 300. Inquiry about authentication is made to an authenticated one of the plurality of data authentication servers 300.

Due to this, because inquiry about authentication is made to an authenticated one of the data authentication servers 300, it is possible to secure the authority concerning license information. Accordingly, design resource data can be protected further positively.

In the second exemplary embodiment, the printer 200 corresponds to a output apparatus of exemplary embodiment 5, 16 or 48, the steps S306-S312, S316-S320 correspond to apparatus authenticating device of exemplary embodiment 5 or 16 or to an apparatus authenticating of exemplary embodiment 32 or 48, and the data authentication server 300 corresponds to a data authentication apparatus of exemplary embodiment 5, 16, 32 or 48.

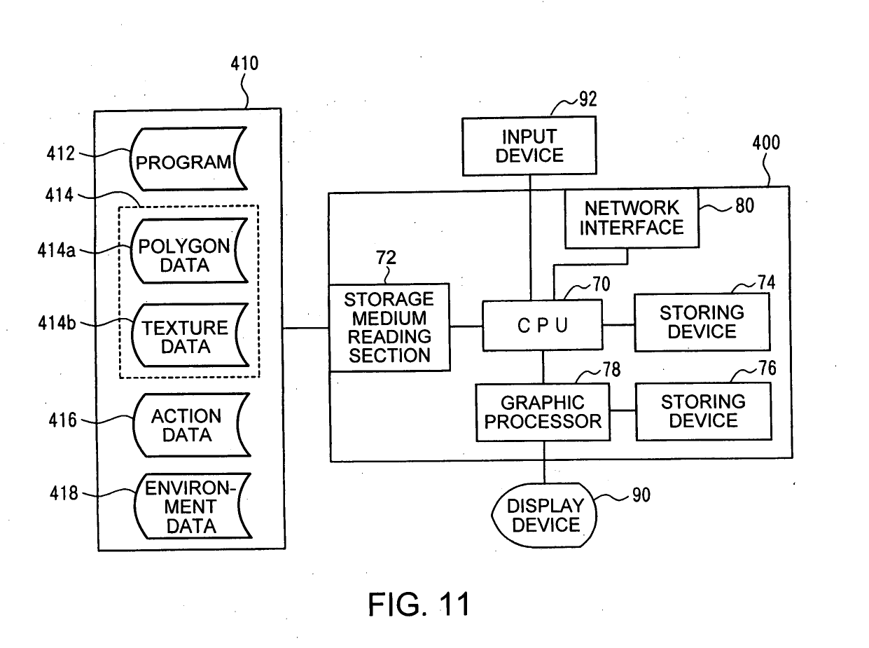

Referring to the drawings, a third exemplary embodiment of the invention is now explained. FIG. 11 is a schematic showing a third exemplary embodiment of a license-authentication functioned output system, output apparatus, data authentication apparatus, design resource output program, data authentication program and license authentication output method according to the present invention.

The third exemplary embodiment is an application of the license-authentication functioned output system, output apparatus, data authentication apparatus, design resource output program, data authentication program and license authentication output method of the present invention, to a case to limit character-image display on a game machine 400, as shown in FIG. 11.

At first, explanation is made on the configuration of a game machine 400 to which the invention is applied, while referring to FIG. 11.

FIG. 11 is a schematic block diagram showing the configuration of the game machine 400.

The game machine 400 is configured, as shown in FIG. 11, with a CPU 70 for control of operation and system overall on the basis of a control program, a storage-medium read section 72 to read data out of a storage medium 410, a storage device 74 such as a RAM to store the data read out of the storage medium 410 and an operation result required in the operation process by the CPU 70, a storage device 76 storing image information, a graphic processor 78 to display a game screen on the display device 90 depending upon image information in the storage device 76, and a network interface 80 mediating to input/output data from/to the external apparatus. Besides, the CPU 70 is connected with, as an exterior device, an input device 92 including a controller or the like to input the operation of a player.

The storage-medium read section 72 includes a CD-ROM drive or the like. When the storage medium 410 is inserted, it reads data out of the storage medium 410 according to control of the CPU 70.

The storage medium 410 stores a game program 412, an object model data 414, action data 416 and environment data 418.

The object model data 414 is data representative of a character image in the game. For example, for displaying a character image of a three-dimensional figure, the object model data 414 is configured with a plurality of polygon data 414a arranged on a virtual three-dimensional coordinate system and texture data 414b describing a surface pattern of a character.

The action data 416 is data defining a featuring motion of the character. For example, it defines a trick motion which the character is to perform in the case of a fighting game, or a character's inclination in swing in the case of a golf game using a professional athlete character.

The environment data 418 is data representative of a game background image or of course data for a golf game.

For example, concerning the object model data 414, in method disclosed in JP-A-5-282464 and JP-A-6-348861, a graphic processor 78 converts (renders) it into bit-map data for output onto a display device 90 and then displayed.

In the configuration regarding the object model data 414 as document data and the graphic processor 78 as a printer 200 in a manner similar to the first and second exemplary embodiment, when there is no available right of object model data 414, it is possible to lower the resolution in displaying a character image or the accuracy of rendering process.

In the third exemplary embodiment, the graphic processor 78 corresponds to a raster image processor of exemplary embodiment 12, 23 or 55.

Incidentally, in the second exemplary embodiment, the printer 200 was configured to authenticate a reliability of the data authentication servers 300 and make an inquiry about authentication to an authenticated one of the plurality of data authentication servers 300. However, this is not limitative, i.e., configuration is possible to make an inquiry about authentication to a particular one of the plurality of data authentication servers 300.

Due to this, by making an inquiry about authentication to a particular data authentication server 300 under duly management, it is possible to secure an authority of license information. Therefore, design resource data can be protected comparatively positively as compared to the related art.

In this case, the printer 200 corresponds to a output apparatus of exemplary embodiment 4, 15 or 47 while the data authentication server 300 corresponds to a data authentication apparatus of exemplary embodiment 4, 15, 31 or 47.

Meanwhile, in the first and second exemplary embodiments, license information was configured including a user ID for identifying a user who is to use design resource data. However, this is not limitative, i.e., license information can be configured including a terminal ID for identifying a user terminal 100 or a printer ID for identifying a printer 200.

This allows for setting a use-permitted scope on each user terminal 100 or each printer 200.

In this case, the terminal ID or printer ID corresponds to subject identification information of exemplary embodiment 6, 17, 26, 33, 41 or 49 or to apparatus identification information of exemplary embodiment 6, 17, 26, 33, 41 or 49 while the printer 200 corresponds to a output apparatus of exemplary embodiment 6, 17, 26, 41 or 49. Meanwhile, the data authentication server 300 corresponds to a data authentication apparatus of the exemplary embodiment 26.

Meanwhile, in the first and second exemplary embodiment, the printer 200 was configured to decide depending upon received use-permitting information whether or not the use is outside a use-permitted scope, and to limit to print the design resource data concerned when it is decided that the use is outside the use-permitted scope. However, this is not limitative, i.e., configuration can be made for limiting to print all the design resource data included in document data received when it is decided that the use is outside the use-permitted scope.

Due to this, because even an authorized user can be limited to print in use outside a use-permitted scope, design resource data can be protected comparatively positively as compared to the related art.

In this case, the printer 200 corresponds to a output apparatus of exemplary embodiment 21, the document data receiving section 10 and step S102 correspond to design resource data input device of exemplary embodiment 10 or 21, while the step S102 corresponds to a design resource data input of exemplary embodiment 37 or 53. Meanwhile, the printing section 18 and steps S116, S118, S122-S126 correspond to design resource output device of exemplary embodiment 10 or 21 while the steps S116, S118, S122-S126 corresponds to a design resource output of exemplary embodiment 37 or 53.

Meanwhile, the first and second exemplary embodiment were configured to process for output limitation on the design resource data as print limitation of design resource data. However, this is not limitative, e.g., configuration is possible to add a design resource with such a message as “Pay the price for use”, to replace the design resource data with the content data of advertisement or the like or to make a processing at other than the printer 200 (e.g., printing data is once transferred to the data authentication server 300 and processed there).

Meanwhile, the first and second exemplary embodiments were configured to process for output limitation on the design resource data not including authentication information. However, this is not limitative, e.g., configuration is possible to regard it as design resource data free of use right and print it as it is.

Meanwhile, the first and second exemplary embodiments were configured including the authentication information in the design resource data. More specifically, configuration is possible to use such a structural description language as XML (extensible Markup Language) to bury it as Meta information in the design resource data. Otherwise, the authentication information can be encrypted and buried in the design resource data. Furthermore, configuration is possible to bury it as electron permeation in the design resource data or to bury the authentication information in the print request.

Meanwhile, in the first and second exemplary embodiments, encryption communication was not implemented in the communication between the printer 200 and the data authentication server 300. However, this is not limitative, i.e., configuration is possible to carry out secure communication by use of SSL (Secure Socket Layer) or the like.

Meanwhile, in the first and second exemplary embodiments, billing is not applied. However, this is not limitative, i.e., configuration is possible to implement a billing process each time authentication is made at the data authentication server 300. Otherwise, for a user having an authorized available right, license information can be registered on condition of paying a predetermined use fee thus carrying out a billing process together.

Meanwhile, in the first and second exemplary embodiments, the printer 200 was configured to acquire use-permitting information or output-limiting information from the data authentication server 300 each time document data is printed. However, this is not limitative, i.e., the use-permitting information or output-limiting information once received may be stored in the storage device 42 so that the use-permitting information or output-limiting information in the storage device 42 can be utilized when using the same one of design resource data. For example, in the case of available right limited in time or the number of outputs, authentication is made within the limited scope by the utilization of the use-permitting information or output-limiting information of the storage device 42 without making an inquiry about authentication to the data authentication server 300.

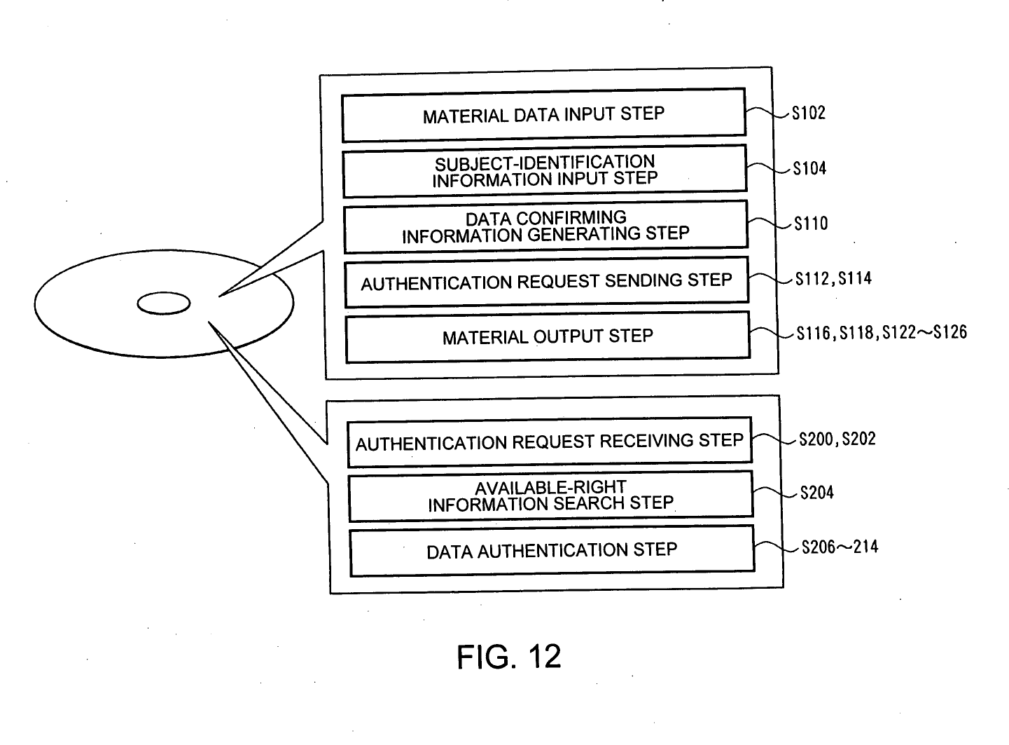

Meanwhile, in the first and second exemplary embodiments, explanation was made on the case to carry out the control program previously stored in the ROM 32, 52 when executing the process shown in the flowchart of FIGS. 3, 5, 9 and 10. However, this is not limitative, i.e., from a storage medium storing a program showing the procedure, the program may be read onto the RAM 34, 54 and then executed, as shown in FIG. 12.

FIG. 12 is a schematic showing a storage medium and a data structure thereof.

Here, the storage medium refers to a semiconductor storage medium such as a RAM or a ROM, a magnetic type storage medium such as an FD or HD, an optical reading schemed storage medium such as a CD, a CDV, an LD or a DVD, or a magnetic storage type/optical reading schemed storage medium such as an MO, including every storage medium provided that it is a storage medium to be read out by the computer.

Meanwhile, the first and second exemplary embodiments explained on the case applying the license-authentication functioned output system, output apparatus, data authentication apparatus, design resource output program, data authentication program and license authentication output method to the network system comprising the Internet 199. However, this is not limitative, i.e., it may be applied to so-called an Intranet for communication on the same scheme as the Internet 199. Naturally, application is possible to the usual network without limiting to the network for communication on the same scheme as the Internet 199.

Meanwhile, in the first and second exemplary embodiments, the license-authentication functioned output system, output apparatus, data authentication apparatus, design resource output program, data authentication program and license authentication output method of the invention was explained on the case for limiting to print a document on the printer 200. However, this is not limitative, i.e., application is possible to other cases within the scope not departing from the gist of the invention. For example, the following mode can be proposed.

Firstly, an RIP (Raster Image Processor) can configured having a function corresponding to the process of steps S100-S120, S124, S126, and the RIP be attached on the usual printer.

Secondly, where displaying an image design resource such as an icon on the display screen of a display, configuration can be made for limiting to display such an image design resource. Due to this, without an authorized use right of the icon, the icon is limited in display.

1. A license-authentication functioned output system to output a design resource and to limit output of the design resource depending upon design resource data, the license-authentication functioned output system comprising:
a license information storing device to store license information, including use-permitting information defining a use-permitted scope of the design resource data and subject identification information identifying a subject of use of the design resource data, by a correspondence to authentication information;
a design resource data input device to input the design resource data to which the authentication information is placed in correspondence;
a subject identification information input device to input the subject identification information;
a license information search device to search through the license information storing device on the basis of the authentication information placed in correspondence to the design resource data inputted by the design resource data input device and to read out license information concerned;
a data authentication device to authenticate a use of the design resource data depending upon the license information read out by the license information search device; and
a design resource output device to output the design resource depending upon the design resource data;
the data authentication device being adapted to decide whether or not the subject identification information inputted by the subject identification information input device is included in the license information read out by the license information search device;
the design resource output device being adapted to output the design resource within a use-permitted scope depending upon the use-permitting information included in the license information read out by the license information search device and the design resource data inputted by the design resource data input device when the data authentication device decides that the subject identification information is included.

2. A license-authentication functioned output system, comprising: connected communicatably with a output apparatus to output a design resource depending upon design resource data and a data authentication apparatus to authenticate a use of the design resource data, thereby limiting output of the design resource, the license-authentication functioned output system comprising:
the output apparatus having a design resource data input device to input the design resource data to which authentication information is placed in correspondence, a subject identification information input device to input the subject identification information identifying a subject of use of the design resource data, an authentication request transmitting device to send, together with an authentication request, authentication information placed in correspondence to the design resource data inputted by the design resource data input device and the subject identification information inputted by the subject identification information input device to the data authentication apparatus, and a design resource output device to output the design resource depending upon the design resource data;
the data authentication apparatus having a license information storing device to store license information including use-permitting information defining a use-permitted scope of the design resource data and subject identification information by a correspondence to the authentication information, an authentication request receiving device to receive the authentication information and the subject identification information together with the authentication request, a license information search device to search through the license information storing device on the basis of the authentication information received by the authentication request receiving device and to read out license information concerned, and a data authentication device to authenticate a use of the design resource data depending upon the license information read out by the license information search device;
the data authentication device being adapted to decide whether or not the subject identification information received by the authentication request receiving device is included in the license information read out by the license information search device, and sending the use-permitting information included in the license information read out by the license information search device to the output apparatus, when it is decided that the subject identification information is included;
the design resource output device being adapted to output the design resource within a use-permitted scope depending upon the use-permitting information received and the design resource data inputted by the design resource data input device when the output apparatus receives the use-permitting information.

3. The license-authentication functioned output system according to claim 2, the license information including data confirming information to confirm a content of the design resource data,
the output apparatus having a data confirming information generating device to generate data confirming information to confirm a content of the design resource data depending upon design resource data inputted by the design resource data input device,
the authentication request transmitting device being adapted to send the authentication information, the subject identification information and the data confirming information, generated by the data confirming information generating device, together with the authentication request, to the data authentication apparatus,
the authentication request receiving device being adapted to receive, together with the authentication request, the authentication information, the subject identification information and the data confirming information,
the data authentication device further deciding whether or not a predetermined relationship is satisfied by the data confirming information received by the authentication request receiving device and the data confirming information included in the license information read out by the license information search device, and sending the use-permitting information included in the license information read out by the license information search device to the output apparatus when it is decided that the predetermined relationship is satisfied and that the subject identification information is included in the license information.

4. The license-authentication functioned output system according to claim 2, the output apparatus and the data authentication apparatuses in plurality, being connected together in communication,
the output apparatus being adapted to make an inquiry about authentication to a particular one of the data authentication apparatuses in plurality.

5. The license-authentication functioned output system according to claim 2, the output apparatus and the data authentication apparatuses in plurality, being connected together in communication;
the output apparatus having an apparatus-authenticating device to authenticate a reliability of the data authentication apparatus, and being adapted to make an inquiry about authentication to an authenticated one of the plural data authentication apparatuses.

6. The license-authentication functioned output system according to claim 2, the subject identification information being apparatus identification information to identify the output apparatus.

7. The license-authentication functioned output system according to claim 2, the subject identification information being user identification information to identify a user who is to use the design resource data.

8. The license-authentication functioned output system according to claim 2, the design resource output device being adapted to decide, depending upon the received use-permitting information, whether or not the use is outside a use-permitted scope, and to limit output of the design resource data inputted by the design resource data input device when it is decided that the use is outside a use-permitted scope.

9. The license-authentication functioned output system according to claim 2, the design resource output device being adapted to decide, depending upon the received use-permitting information, whether or not the use is outside a use-permitted scope, and output the design resource by a predetermined output limiting process depending upon the design resource data inputted by the design resource data input device, when it is decided that the use is outside a use-permitted scope.

10. The license-authentication functioned output system according to claim 2, the design resource output device being adapted to decide, depending upon the received use-permitting information, whether or not the use is outside a use-permitted scope, and to limit output of the design resource data inputted by the design resource data input device and another one of design resource data to be outputted together with the relevant design resource data when it is decided that the use is outside a use-permitted scope.

11. The license-authentication functioned output system according to claim 2, the license information including output limiting information defining an output limiting way of the design resource data,
an output limiting device to limit to output the design resource,
the data authentication device being adapted to decide whether or not the subject identification information received by the authentication request receiving device is included in the license information read out by the license information search device, and send to the output limiting device output limiting information, included in the license information read out by the license information search device, when it is decided that the subject identification information is not included,
the output limiting device being adapted to limit output of the design resource depending upon the received output limiting information when the output limiting information is received.

12. The license-authentication functioned output system according to claim 2, the output apparatus being any one of a printer, a display and a raster image processor for conversion processing of from document data to output data.

13. The output apparatus to output a design resource and to limit to output the design resource depending upon design resource data, the output apparatus comprising:
a design resource data input device to input the design resource data to which authentication information is placed in correspondence;
a subject identification information input device to input subject identification information identifying a subject of the use of the design resource data;
an authentication request transmitting device to send, together with an authentication request, authentication information placed in correspondence to the design resource data inputted by the design resource data input device and subject identification information inputted by the subject identification information input device to the data authentication apparatus; and
a design resource output device to output the design resource depending upon the design resource data;
the design resource output device being adapted, when the relevant output apparatus receives use-permitting information defining a use-permitted scope of the design resource data, to output the design resource within a use-permitted scope depending upon the received use-permitting information and the design resource data inputted by the design resource data input device.

14. The output apparatus according to claim 13, further comprising:
data confirming information generating device to generate data confirming information to confirm a content of the relevant design resource data depending upon design resource data inputted by the design resource data input device,
the authentication request transmitting device being adapted to send, together with the authentication request, the authentication information, the subject identification information and the data confirming information generated by the data confirming information generating device to the data authentication apparatus.

15. The output apparatus according to claim 13, an inquiry about authentication being made to a particular one of the plural data authentication apparatuses.

16. The output apparatus according to claim 13, further comprising:
an apparatus-authenticating device to authenticate a reliability of the data authentication apparatus, and being adapted to make an inquiry about authentication to an authenticated one of the plural data authentication apparatuses.

17. The output apparatus according to claim 13, the subject identification information being apparatus identification information to identify the relevant apparatus.

18. The output apparatus according to claim 13, the subject identification information being user identification information identifying a user who is to use the design resource data.

19. The output apparatus according to claim 13, the design resource output device being adapted to decide, depending upon the received use-permitting information, whether or not the use is outside a use-permitted scope, and to limit output of the design resource data inputted by the design resource data input device when it is decided that the use is outside a use-permitted scope.

20. The output apparatus according to claim 13, the design resource output device being adapted to decide, depending upon the received use-permitting information, whether or not the use is outside a use-permitted scope, and output the design resource by a predetermined output limiting process depending upon the design resource data inputted by the design resource data input device when it is decided that the use is outside a use-permitted scope.

21. The output apparatus according to claim 13, the design resource output device being adapted to decide, depending upon the received use-permitting information, whether or not the use is outside a use-permitted scope, and to limit output of the design resource data inputted by the design resource data input device and another one of design resource data to be outputted together with the relevant design resource data when it is decided that the use is outside a use-permitted scope.

22. The output apparatus according to claim 13, further comprising:
output limiting device to limit output of the design resource,
an the output limiting device being adapted to limit output of the design resource, depending upon the received output limiting information, when the relevant output apparatus receives output limiting information defining an output limiting way of the design resource data.

23. The output apparatus according to claim 13, the apparatus being any one of a printer, a display and a raster image processor for conversion processing of from document data to output data.

24. A data authentication apparatus to authenticate the use of design resource data, the data authentication apparatus comprising:
a license information storing device to store license information, including use-permitting information defining a use-permitted scope of the design resource data and subject identification information identifying a subject of use of the design resource data, by a correspondence to authentication information;
an authentication request receiving device to receive the authentication information and the subject identification information, together with an authentication request;
a license information search device to search through the license information storing device on the basis of the authentication information received by the authentication request receiving device and reading out license information concerned; and
a data authentication device to authenticate a use of the design resource data depending upon the license information read out by the license information search device;
the data authentication device being adapted to decide whether or not the subject identification information received by the authentication request receiving device is included in the license information read out by the license information search devices, and send to the output apparatus, use-permitting information included in the license information read out by the license information search device when it is decided that the subject identification information is included.

25. The data authentication apparatus according to claim 24, the license information including data confirming information to confirm a content of the design resource data,
the authentication request receiving device being adapted to receive the authentication information, the subject identification information and the data confirming information, together with the authentication request,
the data authentication device further deciding whether or not a predetermined relationship is satisfied by the data confirming information received by the authentication request receiving device and the data confirming information included in the license information read out by the license information search device, and sending the use-permitting information included in the license information read out by the license information search device to the output apparatus, when it is decided that the predetermined relationship is satisfied and that the subject identification information is included in the license information.

26. The data authentication apparatus according to claim 24, the subject identification information being apparatus identification information identifying the output apparatus.

27. The data authentication apparatus according to claim 24, the subject identification information being user identification information identifying a user who is to use the design resource data.

28. The data authentication apparatus according to claim 24, the license information including output limiting information defining an output limiting way of the design resource data,
the data authentication device being adapted to decide whether or not the subject identification information received by the authentication request receiving device, is not included in the license information read out by the license information search device, and to send to the output apparatus output limiting information included in the license information read out by the license information search device when it is decided that the subject identification information is not included.

29. A design resource output program for use with a computer, to output a design resource and to limit output of the design resource depending upon design resource data, comprising:
a program for inputting the design resource data to which authentication information is placed in correspondence;
a program for inputting subject identification information identifying a subject of use of the design resource data;
a program for sending, together with an authentication request, authentication information placed in correspondence to the design resource data inputted by the design resource data input and subject identification information inputted by the subject identification information input to the data authentication apparatus; and
a program for outputting the design resource depending upon the design resource data;
the design resource output being adapted to output the design resource within a use-permitted scope depending upon the received use-permitting information and the design resource data inputted by the design resource data input when the computer receives use-permitting information defining a use-permitted scope of the design resource data.

30. The design resource output program according to claim 29, further comprising:
a program for the computer to execute a process including generating data confirming information to confirm a content of the design resource data depending upon the design resource data inputted by the design resource data input,
the authentication request transmitting being adapted to send, together with the authentication request, the authentication information, the subject identification information and the data confirming information generated by the data confirming information generating, to the data authentication apparatus.

31. The design resource output program according to claim 29, further comprising:
a program for the computer to execute a process of making an inquiry about authentication to a particular one of the plural data authentication apparatuses.

32. The design resource output program according to claim 29, further comprising:
a program for the computer to execute a process including authenticating a reliability of the data authentication apparatus, and a process of making an inquiry about authentication to an authenticated one of the plural data authentication apparatuses.

33. The design resource output program according to claim 13, the subject identification information being apparatus identification information identifying the relevant apparatus.

34. The design resource output program according to claim 29, the subject identification information being user identification information identifying a user who is to use the design resource data.

35. The design resource output program according to claim 29, the design resource output being to decide depending upon the received use-permitting information, whether or not the use is outside a use-permitted scope, and to limit output of the design resource data inputted by the design resource data input when it is decided that the use is outside a use-permitted scope.

36. The design resource output program according to claim 29, the design resource output being to decide depending upon the received use-permitting information, whether or not the use is outside a use-permitted scope, and to output the design resource by a predetermined output limiting process depending upon the design resource data inputted by the design resource data input when it is decided that the use is outside a use-permitted scope.

37. The design resource output program according to claim 29, the design resource output being to decide depending upon the received use-permitting information, whether or not the use is outside a use-permitted scope, and to limit output of the design resource data inputted by the design resource data input and another one of design resource data to be outputted together with the relevant design resource data when it is decided that the use is outside a use-permitted scope.

38. The design resource output program according to claim 29, further comprising:
a program for the computer to execute a process including limiting output of the design resource,
the output limiting being to limit output of the design resource depending upon the received output limiting information when the computer receives output limiting information defining an output limiting way of the design resource data.

39. A data authentication program for use with a computer, to authenticate the use of design resource data, comprising:
a program for the computer capable of making use of a license information storing device to store license information including use-permitting information defining a use-permitted scope of the design resource data and subject identification information identifying a subject of use of the design resource data by a correspondence to authentication information, to execute:
receiving the authentication information and the subject identification information, together with an authentication request;
searching through the license information storing device on the basis of the authentication information received in the authentication request receiving and reading out license information concerned; and
authenticating a use of the design resource data depending upon the license information read out in the license information search;
the data authentication for deciding whether or not the subject identification information received in the authentication request receiving is included in the license information read out in the license information search and sending to the output apparatus, use-permitting information included in the license information read out in the license information search when it is decided that the subject identification information is included.

40. The data authentication program according to claim 39, the license information including data confirming information to confirm a content of the design resource data,
the authentication request receiving being to receive the authentication information, the subject identification information and the data confirming information, together with the authentication request,
the data authentication being further to decide whether or not a predetermined relationship is satisfied by the data confirming information received in the authentication request receiving and the data confirming information included in the license information read out in the license information search, and to send the use-permitting information included in the license information read out in the license information search to the output apparatus when it is decided that the predetermined relationship is satisfied and that the subject identification information is included in the license information.

41. The data authentication program according to claim 39, the subject identification information being apparatus identification information identifying the output apparatus.

42. The data authentication program according to claim 39, the subject identification information being user identification information identifying a user who is to use the design resource data.

43. The data authentication program according claim 39, the license information including output limiting information defining an output limiting way of the design resource data,
the data authentication being to decide whether or not the subject identification information received in the authentication request receiving is not included in the license information read out in the license information search, and to send to the output apparatus output limiting information included in the license information read out in the license information search when it is decided that the subject identification information is not included.

44. A license authentication output method to output a design resource and to limiting output of the design resource depending upon design resource data, the license authentication output method comprising:
inputting the design resource data to which authentication information is placed in correspondence;
inputting the subject identification information identifying a subject of use of the design resource data;
searching through the license information storing device storing license information including the use-permitting information defining a use-permitted scope of the design resource data and the subject identification information by a correspondence, to authentication information on the basis of the authentication information placed in correspondence to the design resource data inputted in the design resource data input and of reading out license information concerned;
deciding whether or not the subject identification information inputted in the subject identification information input is included in the license information read out in the license information search; and
outputting the design resource within a use-permitted scope depending upon the use-permitting information included in the license information read out in the license information search and the design resource data inputted by the design resource data input when the data authentication decides that the subject identification information is included.

45. A license authentication output method, comprising connecting communicatably, a output apparatus to output a design resource depending upon design resource data and a data authentication apparatus to authenticate a use of the design resource data, thereby limiting to output the design resource, the output apparatus including:
inputting the design resource data to which authentication information is placed in correspondence;
inputting subject identification information identifying a subject of use of the design resource data; and
sending, together with an authentication request, authentication information placed in correspondence to the design resource data inputted in the design resource data input and the subject identification information inputted in the subject identification information input to the data authentication apparatus;
the data authentication apparatus, including:
receiving the authentication information and the subject identification information, together with the authentication request;
searching through the license information storing device storing license information including use-permitting information defining a use-permitted scope of the design resource data and the subject identification information by a correspondence to authentication information on the basis of the authentication information received in the authentication request receiving; and
deciding whether or not the subject identification information received in the authentication request receiving is included in the license information read out by the license information search, and sending the use-permitting information included in the license information read out by the license information search to the output apparatus when it is decided that the subject identification information is included;
the design resource output device including:
outputting the design resource within a use-permitted scope depending upon the use-permitting information received and the design resource data inputted in the design resource data input when the output apparatus receives the use-permitting information.

46. The license authentication output method according to claim 45, the license information including data confirming information to confirm a content of the design resource data, the output apparatus, including:
generating data confirming information to confirm a content of the design resource data depending upon the design resource data inputted by the design resource data input,
the authentication request transmitting including sending the authentication information, the subject identification information and the data confirming information generated in the data confirming information generating, together with the authentication request, to the data authentication apparatus,
the authentication request receiving including receiving, together with the authentication request, the authentication information, the subject identification information and the data confirming information,
the data authentication including deciding whether or not a predetermined relationship is satisfied by the data confirming information received in the authentication request receiving and the data confirming information included in the license information read out in the license information search, and sending the use-permitting information included in the license information read out in the license information search to the output apparatus, when it is decided that the predetermined relationship is satisfied and that the subject identification information is included in the license information.

47. The license authentication output method according to claim 45, the output apparatus and the data authentication apparatuses in plurality are connected in communication together, the output apparatus, including:
making an inquiry about authentication to a particular one of the plural data authentication apparatuses in plurality.

48. The license authentication output method according to claim 45, the output apparatus and the data authentication apparatuses in plurality being connected in communication together, the method further including:
authenticating, for the output apparatus, a reliability of the plural data authentication apparatus, to make an inquiry about authentication to an authenticated one of the plural data authentication apparatuses.

49. The license authentication output method according to claim 45, the subject identification information being apparatus identification information to identify the output apparatus.

50. The available authentication output method according to claim 45, the subject identification information being user identification information identifying a user who is to use the design resource data.

51. The license authentication output method according to claim 45, the design resource output being to decide, depending upon the received use-permitting information, whether or not the use is outside a use-permitted scope, and to limit output of the design resource data inputted by the design resource data input when it is decided that the use is outside a use-permitted scope.

52. The license authentication output method according to claim 45, the design resource output being to decide, depending upon the received use-permitting information, whether or not the use is outside a use-permitted scope, and to output the design resource by a predetermined output limiting process depending upon the design resource data inputted in the design resource data input when it is decided that the use is outside a use-permitted scope.

53. The license authentication output method according to claim 45, the design resource output is deciding, depending upon the received use-permitting information, whether or not the use is outside a use-permitted scope, and to limit output of the design resource data inputted in the design resource data input and another one of design resource data to be outputted together with the design resource data when it is decided that the use is outside a use-permitted scope.

54. The license authentication output method according to claim 45, the license information including output limiting information defining an output limiting way of the design resource data,
the method further including limiting to output the design resource,
the data authentication being to decide whether or not the subject identification information received in the authentication request receiving is included in the license information read out in the license information search, and to send to the output apparatus, output limiting information included in the license information read out in the license information search when it is decided that the subject identification information is not included,
the output limiting being to limit output of the design resource depending upon the received output limiting information when the output limiting information is received.

55. The license authentication output method according to claim 45, the output apparatus being any one of a printer, a display and a raster image processor for conversion processing of from document data to output data.
